(19) United States
(12) Patent Application Publication
(10) Pub. No.: US 2015/0287094 A1
(43) Pub. Date: Oct. 8, 2015

(54) SYSTEM AND METHOD FOR DRIVING CROSS-PLATFORM INTEREST AND INTERACTIVITY AROUND ADVERTISING INFORMATION

(71) Applicant: Craig P. Mowry, Southampton, NY (US)

(72) Inventor: Craig P. Mowry, Southampton, NY (US)

(21) Appl. No.: 14/681,964

(22) Filed: Apr. 8, 2015

Related U.S. Application Data
(60) Provisional application No. 61/976,687, filed on Apr. 8, 2014.
(60) Provisional application No. 62/012,070, filed on Jun. 13, 2014.
(60) Provisional application No. 62/023,029, filed on Jul. 10, 2014.
(60) Provisional application No. 62/024,787, filed on Jul. 15, 2014.
(60) Provisional application No. 62/036,962, filed on Aug. 13, 2014.
(60) Provisional application No. 62/040,832, filed on Aug. 22, 2014.
(60) Provisional application No. 62/084,867, filed on Nov. 26, 2014.
(60) Provisional application No. 62/120,176, filed on Feb. 24, 2015.

(51) Int. Cl. G06Q 30/02

(52) U.S. Cl. CPC G06Q 30/0269

(57) ABSTRACT

A system and method are disclosed for providing interactive computer managed media bartering. Information representing criteria permitting use of personal information and/or media within advertising is received from a first user. Targeted advertising placement requests including criteria for targeting users and criteria related to requests to barter for advertising. A value representing respective advertising that may be paid with products, goods and/or services is determined based on a demonstrated interest of a plurality of users in the advertiser. Information from the first user and criteria from advertisers are processed to determine contextual elements to incorporate within advertisements. A numerical value representing an incentive for a targeted user to receive and/or be included within the contextual information is determined. The numerical value is applicable toward a redemption option. Advertisements with the contextual elements are generated and transmitted to an advertisement receiving user. The redemption option is provided to the targeted user.

### CROSS-REFERENCE TO RELATED APPLICATIONS

This application is based on and claims priority to U.S. provisional patent application Ser. No. 61/976,687, filed on Apr. 8, 2014, and further claims priority to U.S. provisional patent application Ser. No. 62/012,070, filed on Jun. 13, 2014, U.S. provisional patent application Ser. No. 62/023,029, filed on Jul. 10, 2014, U.S. provisional patent application Ser. No. 62/024,787, filed on Jul. 15, 2014, U.S. provisional patent application Ser. No. 62/036,962, filed on Aug. 13, 2014, U.S. provisional patent application Ser. No. 62/040,832, filed on Aug. 22, 2014, U.S. provisional patent application Ser. No. 62/084,867, filed on Nov. 26, 2014, and U.S. provisional patent application Ser. No. 62/120,176, filed on Feb. 24, 2015, the entire contents of all of which are incorporated by reference as if set forth herein in their respective entireties.

### FIELD

The present application relates, generally, to networking and, more particularly, to a providing bartering services.

### BACKGROUND

For Internet advertising, the relevance of being able to target user determined and defined micro-demographics is invaluable. Unfortunately, a poorly focused myriad of solicitations broadcast to millions of Internet users and mail box holders currently in use is ineffective.

### SUMMARY

In one or more implementations, the present application provides an interactive computer managed media bartering system and method. Using a processor executing instructions stored on non-transitory processor readable media, information representing at least criteria that permits using a first user's personal information and/or personally generated media within advertising is received receive from a first user via user computing device. Targeted advertising placement requests that include at least criteria for targeting user(s) and criteria related to a request to barter for all or part of advertising with at least one product, good and/or service are received from advertisers via at least one advertiser computing device.

Moreover, a value representing an amount and/or ratio of respective advertising that may be paid with at least one product, good and/or service is determined in accordance with a demonstrated interest of a plurality of users in the at least one advertiser product, good and/or service. At least the information received from the first user and at least some of the criteria received from at least one of the advertisers are processed to determine at least one contextual element to incorporate within an advertisement. The contextual element includes at least some of the personal information and/or personally generated media specific to at least one user. At least one advertisement with the determined at least one contextual element is generated. A numerical value that represents at least an incentive for a targeted user to receive and/or be included within the contextual information within the advertisement is also determined. The numerical value is applicable toward a redemption option associated with the at least one advertiser product, good and/or service. The generated advertisement is transmitted to at least one computing device associated with an advertisement receiving user and the redemption option is provided to the targeted user.

Features and advantages of the present application will become apparent from the following description of the invention that refers to the accompanying drawings.

### BRIEF DESCRIPTION OF THE DRAWINGS

FIG. 1 is a block diagram that illustrates an example of a loop of benefit to brands and users in accordance with an embodiment.

FIG. 2 demonstrates some of the criteria associated with an example ad placement via an interface in accordance with the present application.

FIG. 3 illustrates an advertiser receiving consummation of an aspect of the ad placement herein.

FIG. 4 illustrates users accessing an example incentive program catalog that is managed by a computing module in accordance with the present application.

FIG. 5 shows a diagram of a portal in accordance with an embodiment.

FIGS. 6A-D show an example of a user control and rewards system via a user profile in accordance with the portal.

FIGS. 7A-D show an example of how advertisers provide “ad buy criteria” using cross-venue custom relevance in accordance with the portal.

FIG. 8 illustrates an example of how user relevance is increased in the portal in accordance with an embodiment.

FIG. 9 shows an example of how a user's willingness and receptiveness can be amplified within the portal in accordance with the present application.

FIG. 10 illustrates an example of how to drive incentive catalogs with advertiser goods in accordance with the portal.

FIG. 11 provides an example of an ad placement report within the portal.

FIG. 12 provides an example of a redemption report in accordance with the portal.

FIG. 13 is a flow chart illustrating an example of an ad buy sequence in accordance with one or more embodiments.

FIG. 14 is a diagram of an example hardware arrangement that operates for providing the systems and methods disclosed herein.

FIG. 15 is a diagram of the functional elements of an information processor disclosed herein.

FIG. 16 is a flow chart illustrating an example of the interactive computer managed media bartering system and method in accordance with one or more embodiments.

### DETAILED DESCRIPTION

In accordance with one or more embodiments of the present application, disclosed herein is a computer operable system, method and application for driving interest and interactivity around advertising information.

The present application provides a systems and methods that increase relevance of information to users of internet sites and related interactive venues. Moreover, a user's willingness to interact with paid information and solicitations for information, or advertiser valued actions is amplified as a function of the teachings herein.

In at least one embodiment, at least one advertising placement interface is provided that receives input by advertising computer user(s) (hereinafter “advertisers”) of criteria/parameters (hereinafter “criteria”) associated with advertising information and/or solicitations for information (hereinafter “advertising”).

Further, at least one computing module (hereinafter the “hub”) is configured to manage information and evaluate users across various platforms based on traits, preferences and/or information gleaned from data that are permissibly or passively provided by users knowingly or unknowingly. The information from users may be received from their interactivity or other databases accessed. The hub can be enabled to make real time and or future based determinations of user(s) and/or platforms relevant to at least fulfilling the criteria. Further, in at least one embodiment, the hub manages programming designed to balance user interest (such as likelihood to remain engaged and interacting) as a valued factor in permitting the satisfaction of hub-selected, advertising-related criteria.

In one or more embodiments, a computing module and/or programming can be provided to manage an incentive program, (hereinafter “incentives”) related to credits associated with goods and services, at least some related to advertisers and payment for all or part of their advertising. Thus, at least one provider of goods and/or services is acquiring all or part of advertising associated with placement(s) made via the advertising placement interface.

One or more embodiments of the present application can also include a user accounting function for users to accrue points related to incentives, by agreeably allowing for receipt of advertising and/or for providing desired responsive information, including valued advertiser action(s) by users. In at least one embodiment variable controls, such as “temperature” settings, allow users to adjust a degree of willingness to receiving advertising, which affects an aspect of incentives for their own user experiences.

In one or more embodiments of the present application, user permission-related instruction(s) can be included via system/hub computing, which can affect not only a user's ability to receive paid information, but further can affect the permissible use of the user's own information being included within information conveyed to other users. This can include paid information that involves brand information married with social information, such as preference information related to other identified user(s) and/or groups of users. One or more embodiments of the present application link incentives with permissions and degrees of permission, uniquely.

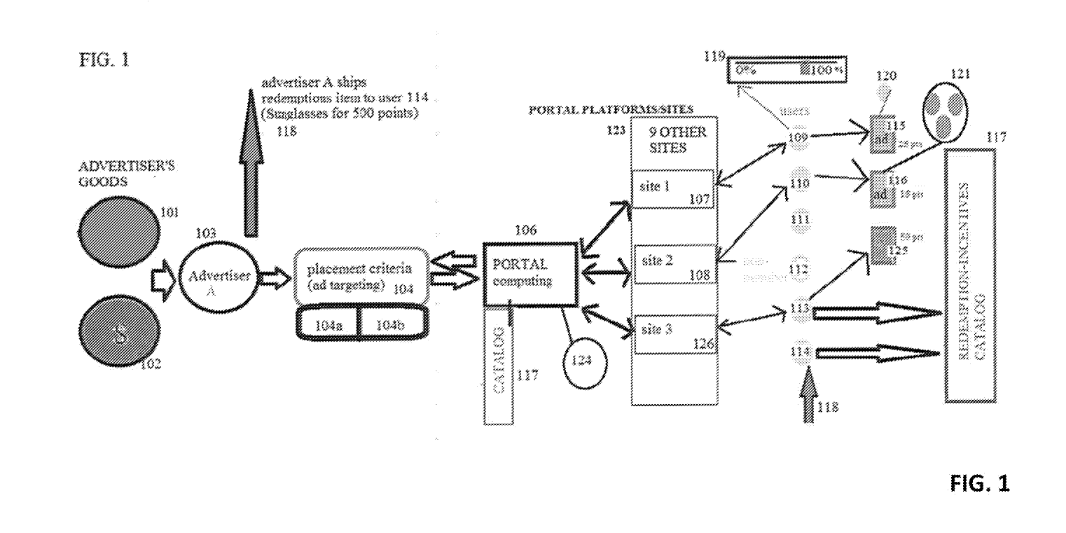

The present application thus provides one or more embodiments that accomplish a loop of benefit to brands and users, around the same goods at least. In essence, a “breeder reactor” of information exchange and mutual interest between brand and user(s) can be powered by incentives directly associated (in one or more embodiments) with the goods (and services) being promoted by advertisers. To demonstrate this loop, which can increase the efficiency of advertising and can amplify the effectiveness of cross-platform media buying (including socially associated paid information) facilitated by at least one embodiment of the present application, FIG. 1 is referred to.

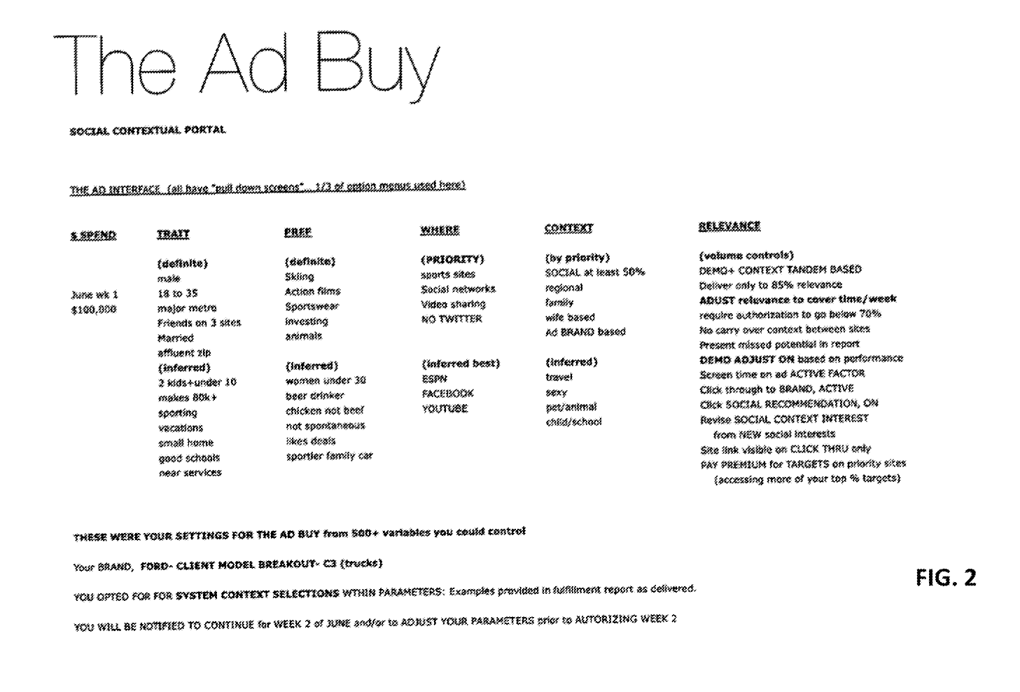

In FIG. 1, Advertiser A 103 (Ray-Ban Sunglasses), via computing device 104, manages Ad Placement Interface Information 104a, and Placement Criteria 104b, conveyed via Portal Computing (“hub”) 106. FIG. 2 demonstrates some of the criteria associated with an example ad placement via such an interface, received as 104b, as only a snapshot of some system managed criteria related to an advertiser's paid media order.

Referring back to FIG. 1, Advertiser A 103 provides criteria for his placement, including an option provided potentially customized to him related to “Involving Goods” (for example based on “retail price”) as a component of all or part of his payment for his advertising and/or other paid information, such as questions/solicitations, 115, 116, 125. In the instance of Advertiser A 103, the options offered by Hub 106 and interface data allows for a selected option, which in the example shown is an ad placement of $100,000 based on 50,000 cash, 102, and 50,000 in “last years goods,” including unsold items, 101, returned to Advertiser A from his retail establishments and retail partners.

In providing criteria 104b for an ad placement to the hub 106 via computing device 104, Advertiser A 103 further designates criteria associated with traits and preferences of his target users, e.g., traits and/or preferences of optionally including at least some limitations on the platforms 123 these users are to receive advertising related to Advertiser A 103, from hub computing 106.

For example and with continued reference to FIG. 1, Advertiser A 103 is charged a fee to fulfill his request to provide incentives (redeemable via hub 106 and managed via e-catalog 117) to at least a range of targeted users. The range of users, including users 109, 110, 113, 114 can relate to an aspect of ad interface criteria 104a provided to advertiser computer 104. In this example, Advertiser A has paid a “premium” to provide enhanced incentive points to users who meet specific, desirable criteria, which for Advertiser A represents likely buyers of branded goods (e.g., sunglasses).

In at least one embodiment, some users are targeted for advertising without receiving incentives, while other users can be designated for incentive amplification within the ads, though they are at a lesser “level” than others. All can be put at the option of advertisers, as information within the ad interface criteria/options 104a provided as responsive ad criteria 104b. The actual implementation by hub computing device 106 may not be determined by advertisers, such as Advertiser A 103, rather determined by hub 106, which can manage other variable(s), including those specifically related to users' experiences, including information relevance, interest and engagement factors. The priorities managed by hub 106 thus can include the priorities of advertisers, including Advertiser A 103, and the interest and interactive willingness of users, including users 109 through 114 and featured users 120 and user group 121.

Still referring to FIG. 1, in this Ad Placement and Platform Partnership Portal managed by hub 106, there are shown twelve participating sites 123, which include ten that are venues also provided as PDA device “apps” to users.

In implementing Advertiser A's 103 supplied interface data, (completed and returned data 104b) thousands of users can receive advertisements over three networked platforms/sites, which are themselves members of the Portal Network, such as over a one week period. These three sites (107, 108, 126) can be determined from weighing ad criteria 104b and user relevance factors 124, which can be managed by hub 106 and updated based on information including the interactivity patterns of users of, for example, the twelve members platform/sites 123.

In determining relevant users for information associated with Advertiser A's placement, social associations can be factored/weighted. For example, relevance for those expressly named by users (such as “friends” or other designated and/or user created “bins” of users) and those inferred of interest to users, such as groups sharing traits and/or preferences associated with ones of relevance to a user that the user may have actual or likely determined (e.g., by hub 106) interest in.

Users 109, 110, 112, 113, 114, 120 and user group 121 can provide instructions related to a permission to have at least some of personal information used by the Portal to provide paid information. In one or more embodiments, information can be conveyed to other users as a unique incentive/permission opportunity for users to receive and impact. In FIG. 1, User 109 demonstrates this interest at a 60% setting on “incentive and permissions volume control” (hereinafter “IPVC”), 119. This allows for his user name, photo, and “public preferences and traits” to be used in such messages and to allow for his information to be actively engaged in ads, questions, and recommendations sent to him. The frequency of paid information being conveyed to him can also be impacted by the IPVC setting 119.

Some users may not allow any or all of this information via their own IPVC settings 119, while other users may permit even more information, including private traits and preferences, to be used aggressively for advertisement creation by hub 106, in exchange for receiving more incentives potentially than other users who have opted for lower volume on the IPVC 119. In one or more embodiments, simpler such controls can allow for “yes/no” or “A, B, C,” with IPVC 119 demonstrating a more variable option setting device, providing 100 options, e.g., 1 through 100%.

Nuanced management of relevance to meet advertiser priorities, user IPVC settings, and discreet and separate (in some embodiments) user interest inferences, can include weighing psychographic data and related factors deemed by system programming to be useful, to determine user interest likelihood thresholds and engagement with information potential. Thus, the multi-layers relevance management by hub 106 include actively set user willingness controls 119, actively set advertiser priority criteria 104b, and passive (hub determined/managed) relevances 124, to deliver customized socially associated information that is highly relevant and interesting to users while concurrently being highly responsive to ad targeting objectives and various system/hub managed revenue generating opportunities at a given time, across member platforms 123 and available/engaged users.

In at least one embodiment, targeted user 109 receives Advertiser A 103 featuring ad 114, which features user 120, in the sunglass brand ad known to user 109 from another social venue permissibly accessed for information by hub 106. Based on user 109's IPVC setting 119, the permissible access to the database revealing user 120, as relevant to user 109, can provide an impact to points accrued by user 109.

In the example shown in FIG. 1, featured user 120 is also a member of the portal group/platforms 123, and can also receive point(s) for the use of her name, photo, and information revealing a preference associated with the sunglass brand, and even access to a “posted message” she made about the topic of sunglasses. User 120 even can receive points for allowing access to her from those who might receive advertising featuring her, in relation to Advertiser A. In this example, she provided such permissions for 50 advertised brands of the portal managed by hub 106. In one or more embodiments, users may opt to provide no restrictions on the use of their information in ads, thus delivering maximum incentive points via a designation of 100% on their IPVC settings 119.

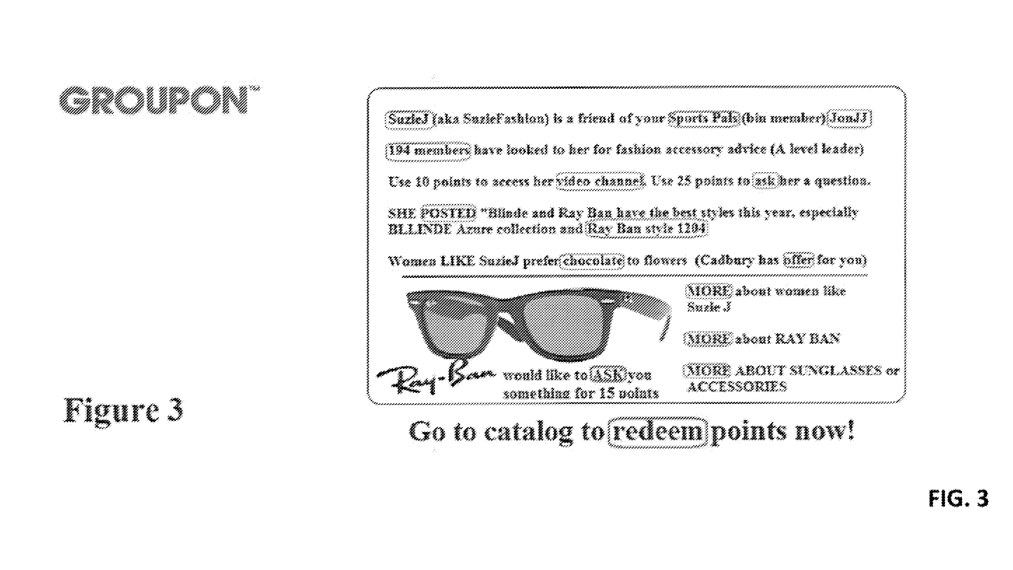

FIG. 3 illustrates a social contextual advertisement for Ray-Ban sunglasses determined relevant to both user 109 to receive for fulfillment of an aspect of Advertiser A's placement criteria 104b, and within the parameters of system relevance/interest and “quality control” criteria 124. This ad features incentivized user 120's personal information and recent message posted valued by the system computing on behalf of Advertiser A 103. In this example, access to user 120 by user 109 can be permissibly allowed based on user 120's own IPVC setting 119. Further, as user 120 is categorized as an “A level authority” and assigned a level of premium status within the portal community, user 109 can use some accrued points to access media (e.g., a video) and a responsive opinion from user 120 to a question posted through incentive linked messaging managed by hub 106. In this example, user 109 uses 10 points to access media of user 120, and 25 points to pose a question. User 120 receives 5 points for the viewing of his or her media by user 109, and further receives 15 points, once the personal response to the question from user 109 is answered in a way that meets hub managed criteria for the incentive.

A unique confluence of variables can affect the points that user 109 and 120 demonstrably accrue in relation to this example scenario, wherein one user is provided with an ad featuring another user.

In this example, Advertiser A 103 has paid or at least designated to pay for desired target user 109 to receive a Ray-Ban Sunglasses ad within the other criteria provided within 104a. User 120 has agreeably, and in this example as a member of the incentive portal program, received 5 points for the use of her name in the context ad delivered to user 109 (featured in FIG. 3). User 109 is on platform 123 member site 107, Groupon, on receiving the social ad featuring user deemed relevant 120. Indeed, user 120 has never been featured in a sunglasses ad before and represents a uniquely customized ad for user 109.

Further in this example, as user 109 is a very desirable target for Advertiser A 103, Ray-Ban Sunglasses (based at least on criteria including income and sporting interests/preferences and gender), had user 109 been interacting within the time period of the ad buy (e.g., one week) on another site, such as 108, it is highly likely that the system via hub 106 would have targeted him and delivered another Ray-Ban ad featuring a distinct social context. This, potentially in relation to a different topic of contextual aspect (e.g., preference), in order to allow the desired user target 109 to receive paid information that hub computing 106 determined to be relevant to him at that time, based in part on the genre/topic of the member site he was logged in on. Here, like user 120, user 109's interactivity around the brand and/or topic (e.g., sunglasses, Ray-Ban, and/or fashion accessories in this instance of hub managed data) elevated user 109 to a premium user for incentives in relation to being willing to have his or her opinion and/or media and/or personal information accessible to other users.

Indeed, other variables can also be factored, including exactly what and/or who the user was interacting or providing instructions with/about at the time of ad determination and creation. This, among many other potential impacting variables relevant to quality control/relevance programming 124, can be designed to at least increase the likelihood of maintaining user 109's interactive engagement and session—in other words to help prevent “boring” the user or leaving the user with a sense of manipulation, or irrelevance, leading to a log out.

FIG. 3 illustrates Advertiser A 103 further receiving consummation of an aspect of the ad placement herein, via an ad delivered to user 109 who is interacting on platform member site 107, receiving Ray-Ban customized ad 115 which (in this instance) features a group social context, namely “women 18 to 35, who like guys who wear sunglasses.” In this example, user 120 is specially featured and accessible as enhanced social context for the brand. A further relevance to user 109 regarding user 120 is that user 120 is determined to be both a “friend” of one user that user 109 has in a personal “bin” of users (labeled “sports pals”). Many of these women in the associated group to which user 120 also belongs were actually solicited by Ray-Ban as a data sampling paid information request, for which they received points. In this example, more desired females for Ray-Ban's data sampling, namely those 20 to 25, in fact were offered an enhanced amount of points to answer the question timely (e.g., “do you like guys who wear sunglasses a lot, including indoors when perhaps they don't need to?”).

FIG. 3 further demonstrates how Advertiser A's 103 information, via the hub 106, can be customized in design/style to suit the relevance and parameters of the platform on which it can be delivered. For example, the format of ads for a Groupon or similar site can be different than the configuration of that information for a uniquely generated ad on ESPN, even if to the same user. In one or more embodiments, customization may not only be context and/or social association and/or incentives provided, but also the technical and artistic needs/parameters of the member platform (e.g., site/venue) can be further factors of information customization and relevance. Aspects of this customization can occur at hub computing 106 and/or platform members' computing (such as 107, 108, 126) and/or via linked computing operability. Indeed, this portal can be a multi-layered, ad selection, creation and determination system with many aspects to be factored relevant to brand, user, system relevance criteria, incentive program parameters, and platform member venue parameters among other factors.

User group 121, which in this example is “men over 40 who are ski enthusiasts,” were associated with a social context of value around information known about ad-receiving user 110, who was targeted by Advertiser A 103 to receive Ray-Ban's advertising if social relevance of an acceptable threshold could be established. In this example, user group 121 met the threshold of relevance to both advertiser criteria and user relevance/interest hub managed thresholds (related to anticipated user interest and/or user experience quality).

The intuitive, adaptable nature of the incentive program shown and described herein can allow advertiser/sampling criteria to be weighed against relevance factors known to the system 124, in order to target and offer/reward the most desirable and willing users to provide valued data. Subjective determinations learned by hub computing 106 or linked computing enhancing system functionality can impact who is targeted for paid information, including brand valued questions, and how much incentive (such as points, or a related measured incentive basis) is offered and/or provided for agreeable responsiveness.

User interactions and expressed willingness to even “answer” hub trafficked questions from brand targeted user can also allow a user to receive points. For example, a person and/or celebrity and/or expert can represent an opinion or response that a user or user group might value. An advertiser can be all or in-part responsible for “points” provided to such a valued user (who responds to other user questions) and/or, in at least one embodiment, the other users themselves can use points to access such premium users, and/or exchange media with them (such as photos/video). In one or more embodiments, accessing images from such premium users and/or desired information, or even live exchanges or access to such exchanges, can require and/or earn points for parties (users) involved, with the goal being, at least in part, to drive desired exchanges for relevance to advertisers and/or users themselves.

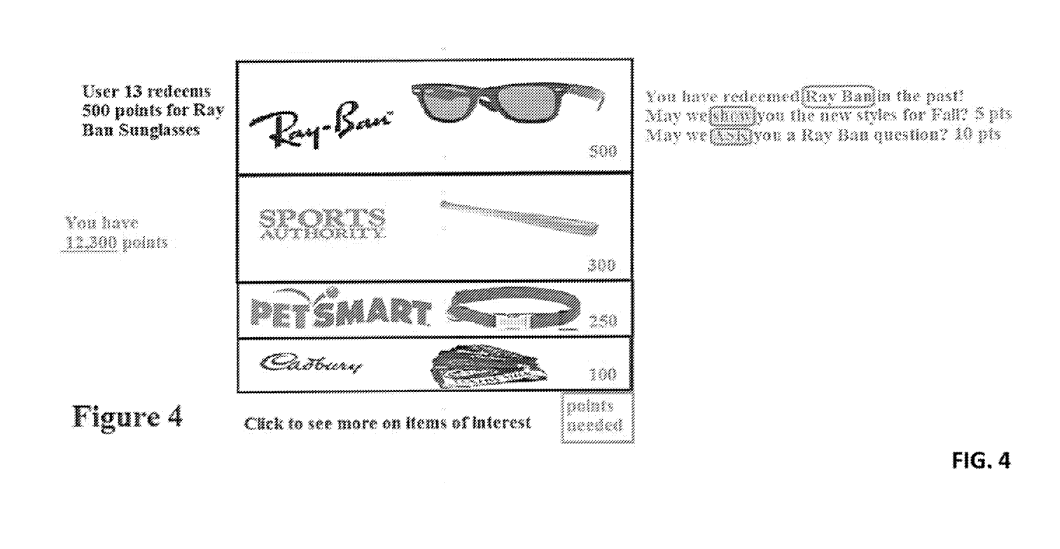

FIG. 4 illustrates users 113 and 114 accessing an example incentive program catalog that is managed by hub 106, or linked computing. In one or more implementations, the incentive program catalog demonstrates a use of points to redeem items from an advertiser. In this example, points are used to “pay” for half of this ad placement 101. These sunglasses redeemed by user 113 were last year's close out style BBX. They were $500 retail price, and can be redeemed based on this price. This maintains the integrity of brand pricing, as typically such items can be sold at discounts as much as 95% and typically 90%, at close out stores. A valued brand selling such items for $50 can degrade new, similar or other brand bearing merchandise.

In this example, the original retail price is maintained as a “redeemed” price. This can allow the Advertiser A 103 to have literally acquired the full sale price last year at retail, $500, in portal group ads on platform site(s) 123, allowing what would have been a “marked down loss on returned unsold goods” to remain a full retail sale, moved over from “sale revenue” to “advertising purchase.”

In this example, no loss occurs from an accounting standpoint, as the old goods are desired by the portal group to fuel the user incentive program. Further, management of redeemed goods can be handled by the participating advertisers on receipt of redemption orders from hub 106 or linked computing. In one or more embodiments, redemption fulfillment by advertisers may need to meet portal standards and terms to allow such payment of all or part of advertising with goods. In one or more embodiments, certain advertiser goods may be more desirable and “premium” to the portal program of incentives, which leaves the variable scenario of some advertisers being able to acquire “more” of the advertising with goods.

In at least one embodiment, terms/limits on “what” goods can also occur, including “last year's” or “new retail” goods, to allow for the redemption catalog to remain interesting and valuable to users, driving responsiveness for data collection (preference information) and to power purchases, click throughs, time spent on ads, and other desirable user events and user experiences on platforms of the portal group/program.

Further, in at least one embodiment, redemptions within a wide-ranging catalog of updating items can provide valued information about user preferences and values. For example, a user redeeming his points for last year's Ray-Ban sunglasses can be an ideal target to receive and/or provide information about this year's new line of sunglasses. Whether it is an ad, an opportunity to buy or link to the new line, or even inform the user of a new product yet to be developed (e.g., color, shapes, product aspects) the user who redeems for an item can be an example of a “client” of the product.

Further, by narrowing such redeemers based on other information about them, within their profile and/or otherwise provided, whether for incentives or not, a focus group of unrivaled value can be created in one or more embodiments. Meaning, for example, “men who play sports avidly who also redeemed a certain style of Ray-Ban” can be narrowed and agreeably sampled for information. This may provide more points for, for example, the new line of Ray-Ban can receive immediate preference sampling data essential for successful product development. This sampling can represent paid media given/received, which itself can be paid for by the advertiser with cash and/or product, based on portal agreement(s) and options provided to this advertiser.

For example, user 113 can be identified as a valued preference sampling target for Advertiser A 103, based in part on a past use of points to redeem Ray-Ban sunglasses, over many other choices in the catalog. Using the style redeemed and information agreeably provided (based on IPVC settings) from user 113's profile and past actions tracked by the portal hub 106 and/or linked computing, delivery of preference sampling question 125 can be made to the user via the fashion site Gilt Group 126, including a 50 point incentive to provide the desired response/action/choice. In this example, an easy selection of an upcoming style option that is preferred and color that is preferred, (informing the Ray-Ban product design team). Compensation from Ray-Ban can provide value to the member site 126 and the sampled user 113, with a margin as well for the portal business itself (managed by hub 106).

Thus, and in one or more embodiments, a system and method are provided that can drive an old product, brand awareness, preference sampling, and willingness to exchange information with/between other users. As a result, high “paid information” prices can be charged and better goods can be included within an incentive system that can allow, at least in part, for goods/services to be provided and/or redeemed in relation to a multi-venue (platform) ad delivery system, and can include a willingness/relevance amplifier that involves users in the determination of their own fate, incentives and exposure to solicitations. In the end, referring to FIG. 1, the manifestation of Advertiser A's 103 ad buy can factor in many parameters and objectives of portal participants, including (but not limited to): users, advertisers, and sites participating/platforms. Thus, any ad buy can essentially be uniquely fulfilled.

For example, just the range of cross-platform users targeted, at any one instant, can be unique. As each participating platform reports within hub computing parameters the essential information about engaged users, many determinations and correlations can be made “on the fly.” These can include relevance to the active advertising buys and relevance of social associations to those users.

More discreet determinations of how much incentive use may be needed to maintain acceptable degrees of relevance to any or all parties involved can further drive determinations of where and how to deliver paid information. Like placing bets in a casino, how an amount of chips are used by one multi-table gamer, on which tables, against which other players and when, is comparable. All of these choices affect the potential value and resulting effect of the use of his chips during the timeframe he gambles.

The present patent application provides a portal including as shown and referred to herein in one or more examples as “BrandAMP,” that includes a cross venue advertising platform and membership incentive venue. The examples included herein demonstrate user and advertiser interactive experiences related to enrollment by users in the venue. The examples further include: purchasing options by advertisers, including options related to purchasing using goods and related user redemptions of goods; contextual advertising and sampling delivered by way of one embodiment of the present application; and advertising and sampling-related advertising placement reports, showing how advertising was fulfilled agreeably by the venue.

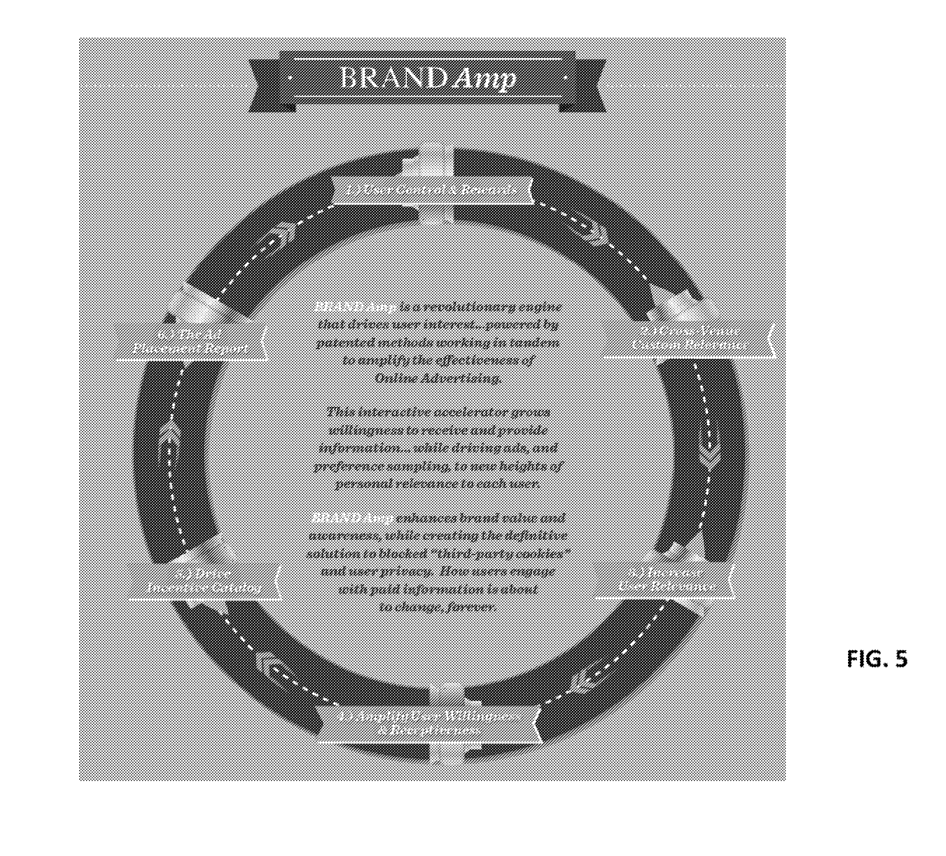

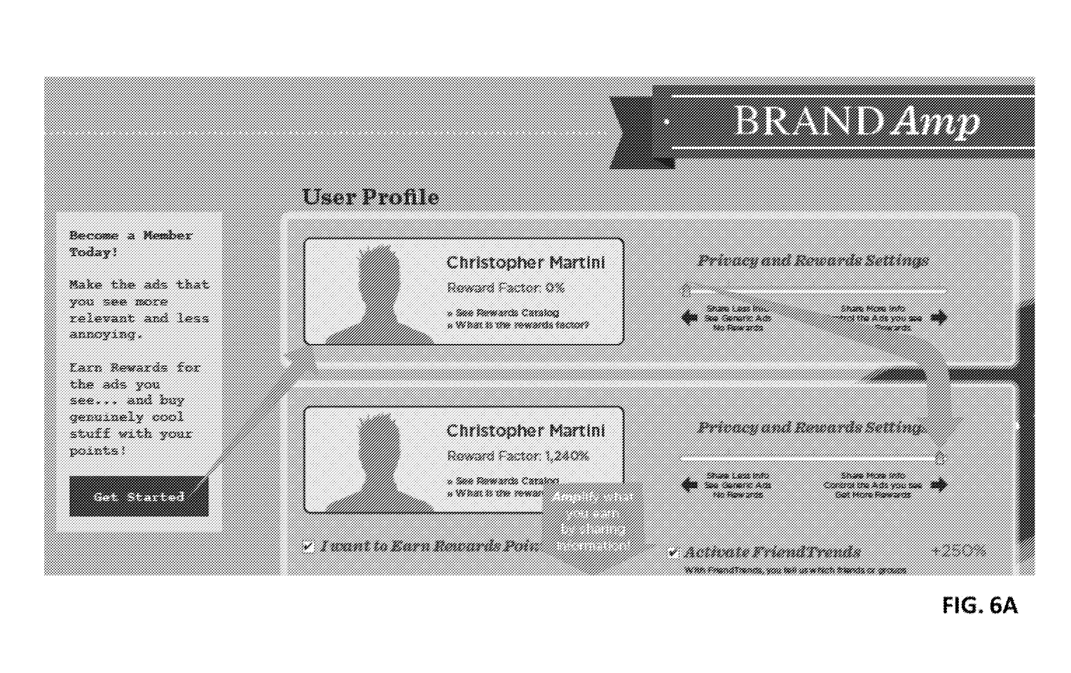

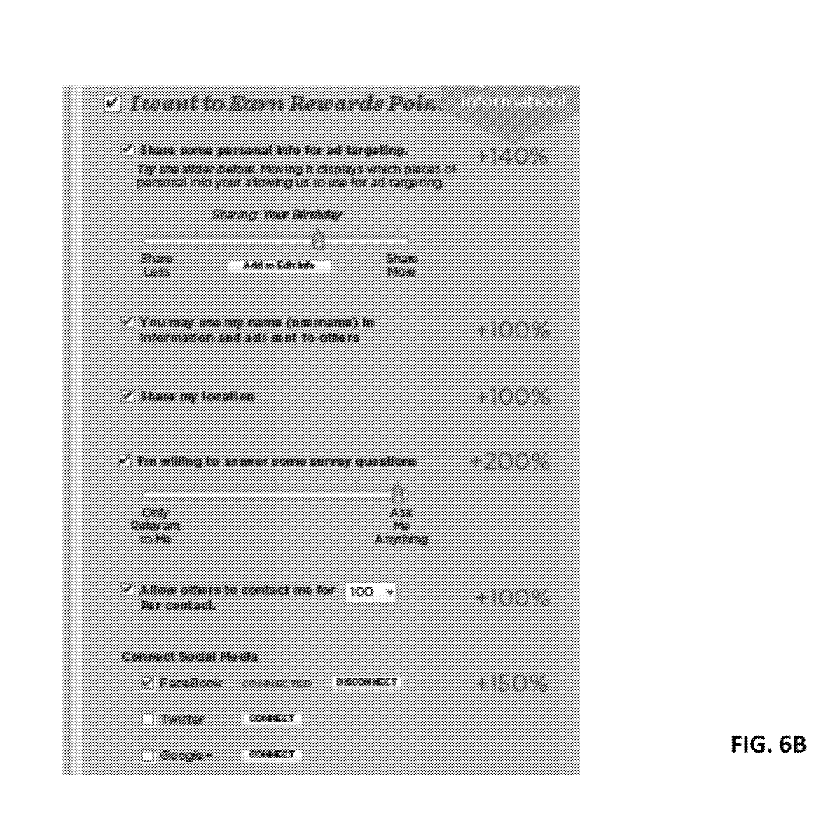

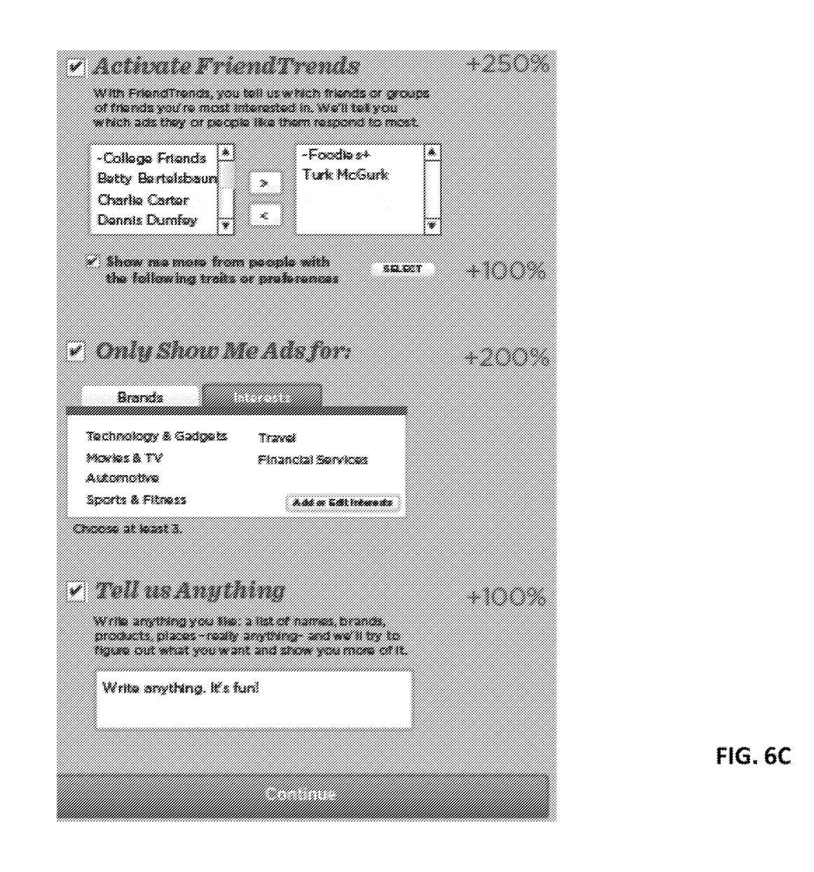

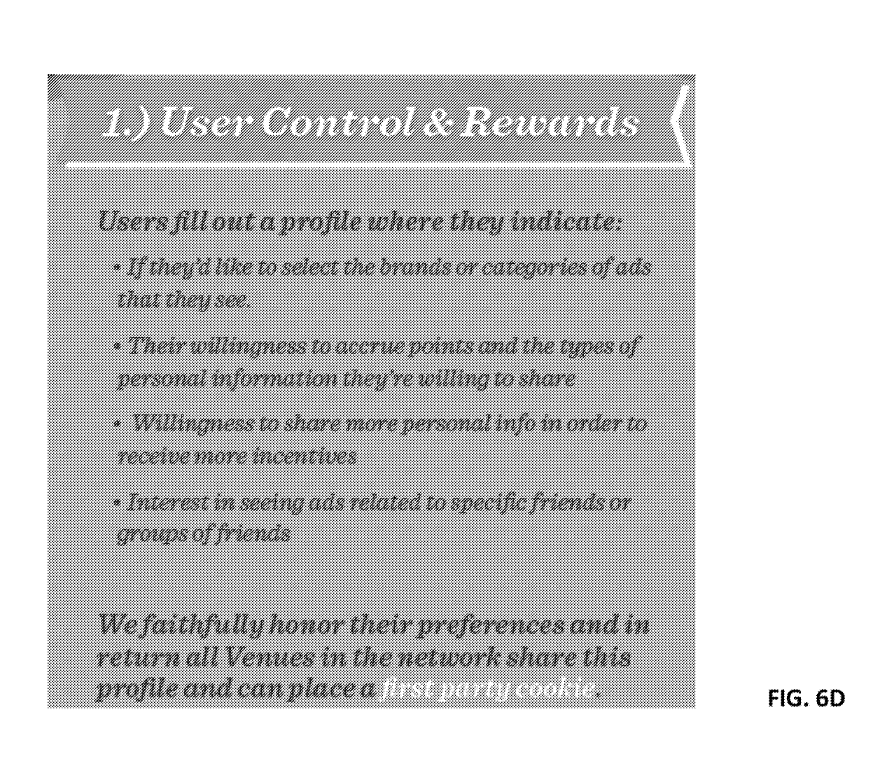

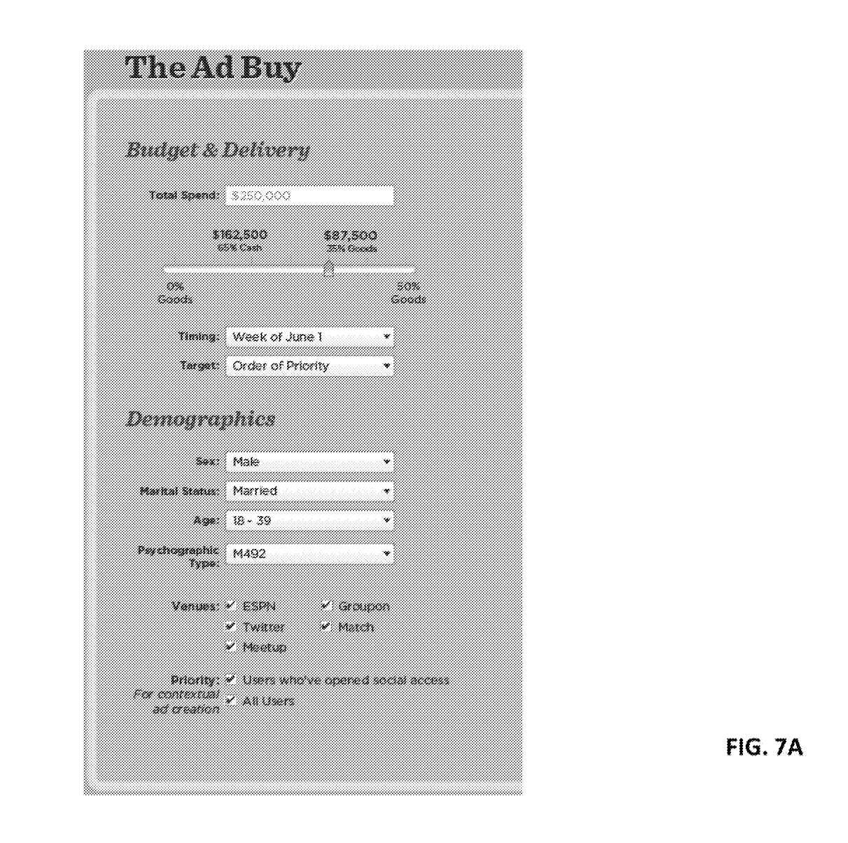

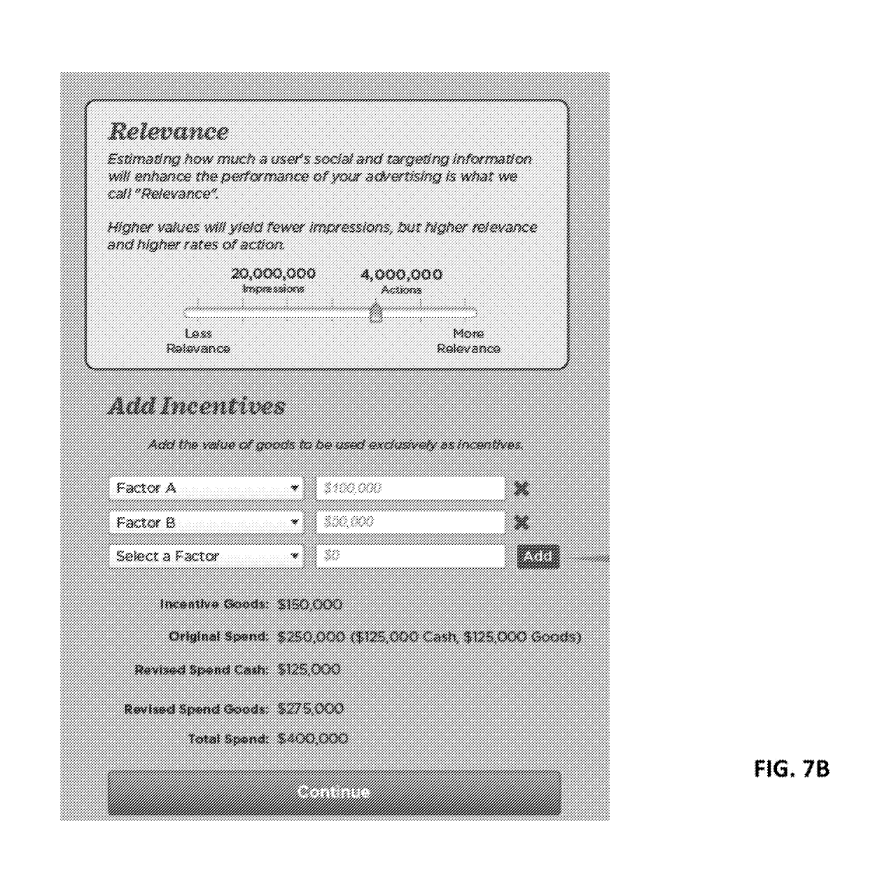

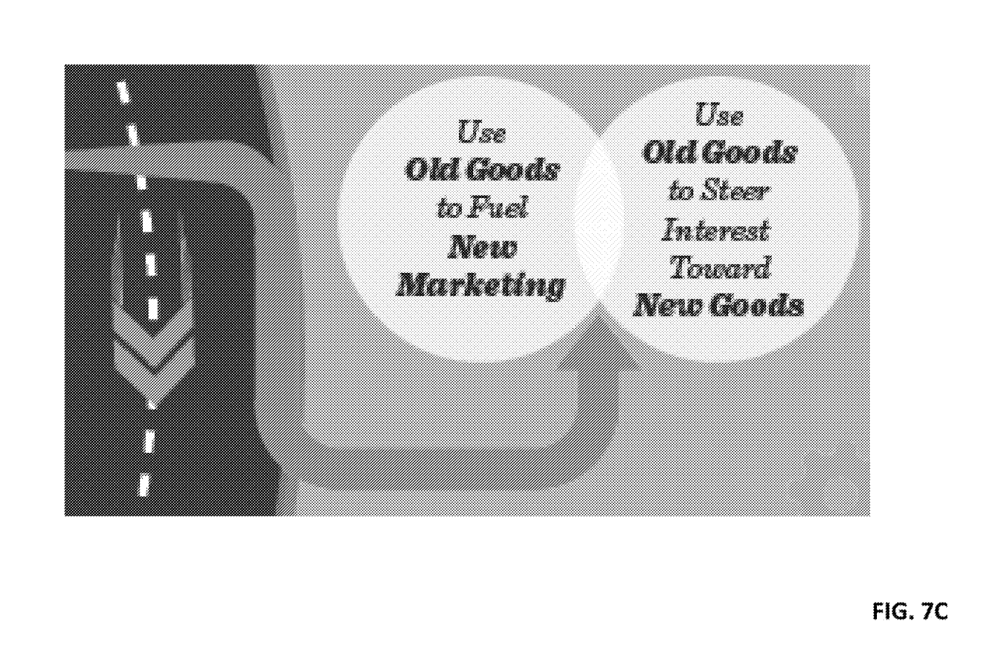

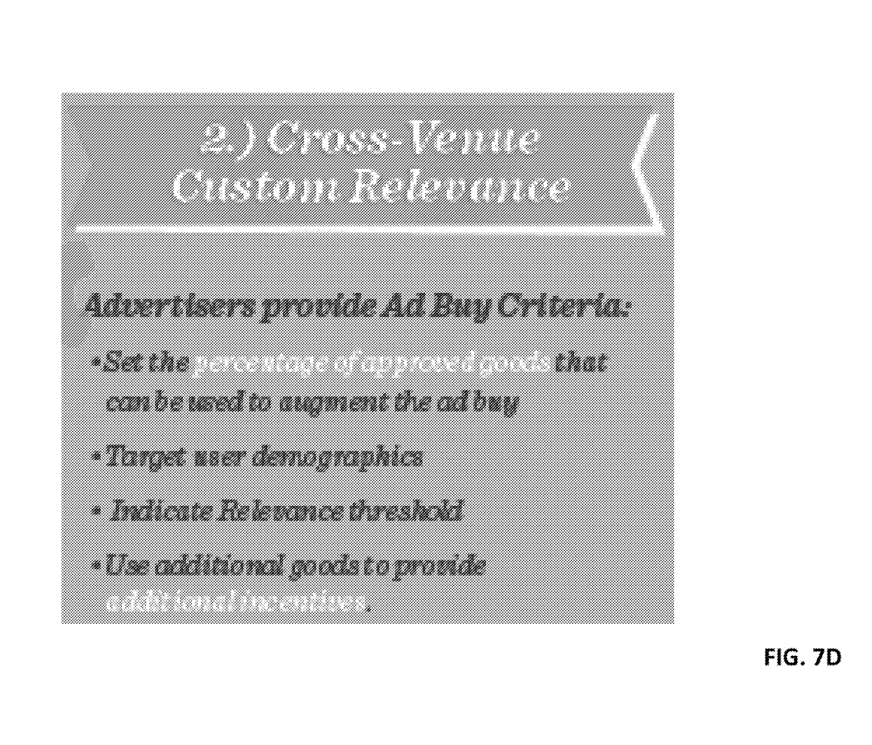

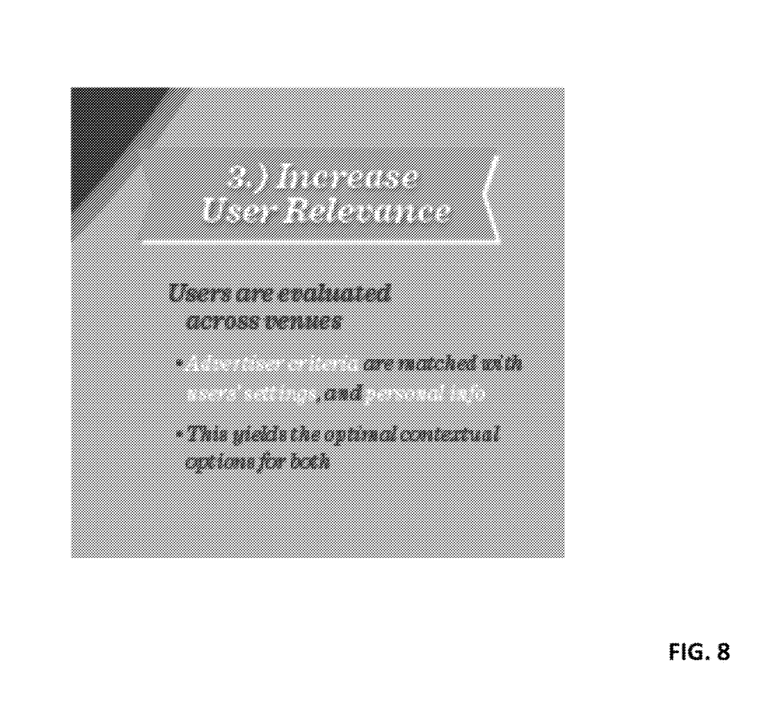

FIG. 5 shows a diagram of an embodiment of the portal “BrandAMP.” FIGS. 6A-D show an example of a user control and rewards system via a user profile in accordance with the “BrandAMP” portal. As exemplified in these figures, a user can fill out a profile where they indicate: 1) if they'd like to select the brands or categories of ads that they see; 2) willingness to accrue points and the types of personal information they're willing to share; 3) willingness to share more personal info in order to receive more incentives; and 4) interest in seeing ads related to specific friends or groups of friends. FIGS. 7A-D show an example of how advertisers provide “ad buy criteria” using cross-venue custom relevance in accordance with the “BrandAMP” portal. As shown in these figures, advertisers can provide ad buy criteria by: 1) setting the percentage of approved goods that can be used to augment the ad buy; 2) targeting user demographics; 3) indicating relevance thresholds; and 4) using additional goods to provide additional incentives. FIG. 8 illustrates an example of how user relevance is increased in accordance with the “BrandAMP” portal. Specifically, in this example, users are evaluated across venues, such that advertiser criteria are matched with users' setting and personal information, thereby yielding the optimal contextual options for both.

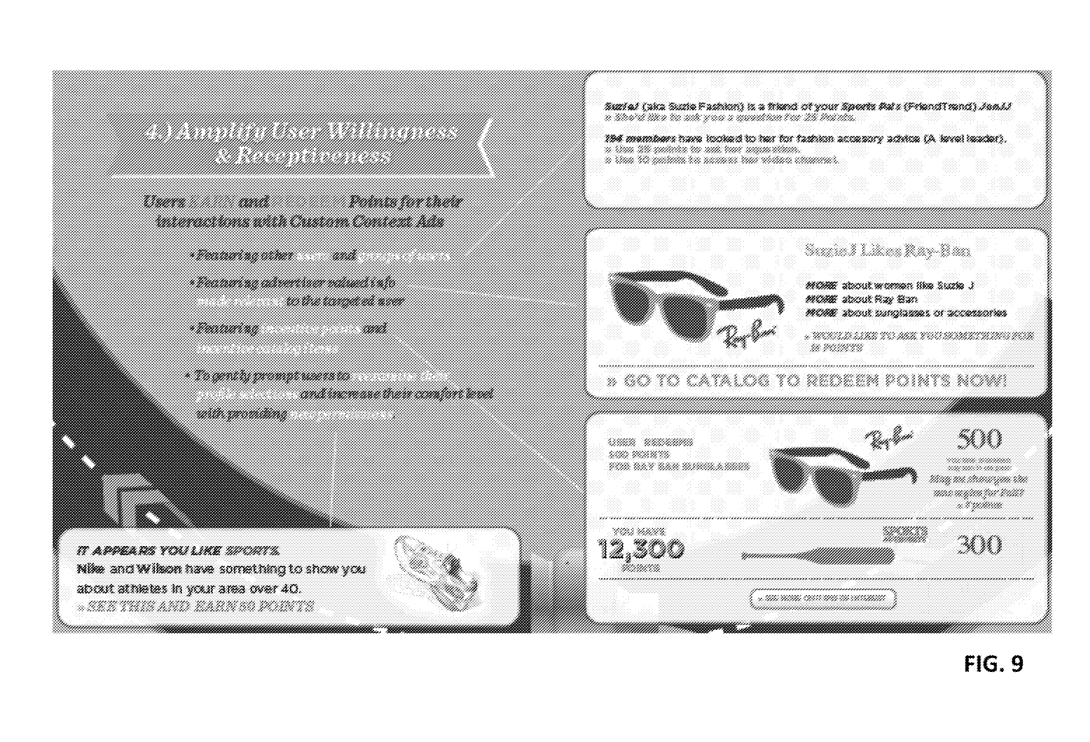

FIG. 9 shows an example of how a user's willingness and receptiveness can be amplified within the “BrandAMP” portal. In this example, users can earn and redeem points for interactions with custom context ads in various ways, including: 1) featuring other users and groups of users; 2) featuring advertiser valued information made relevant to the targeted user; 3) featuring incentive points and incentive catalog items; and 4) gently prompting users to reexamine their profile selections and increase their comfort level with providing new permissions.

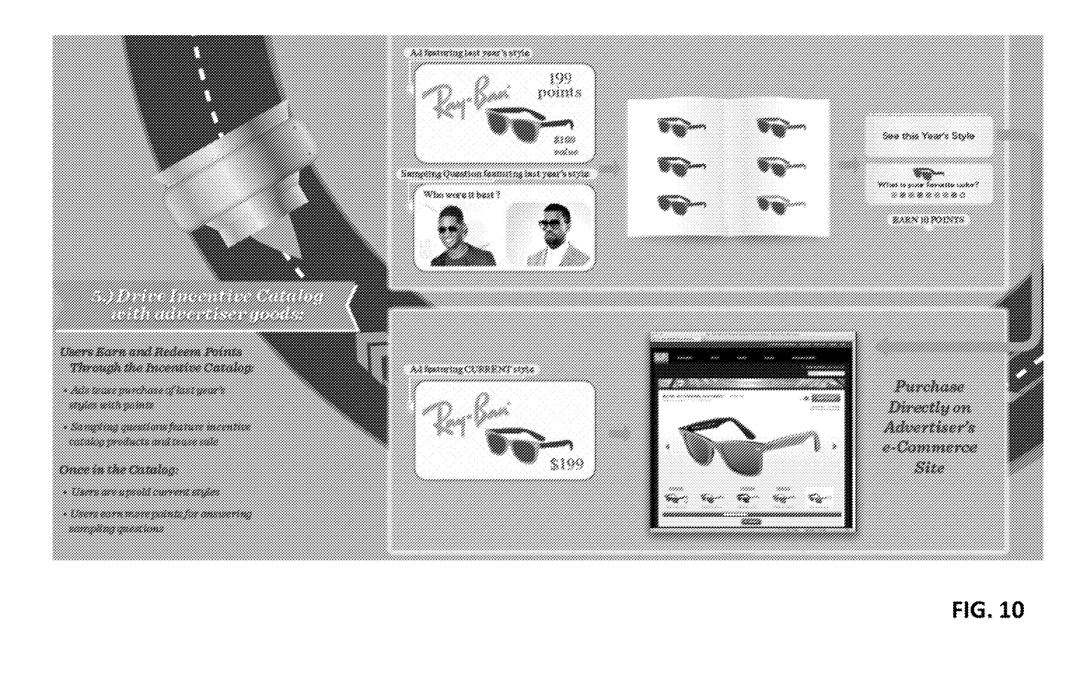

FIG. 10 illustrates an example of how to drive incentive catalogs with advertiser goods in accordance with the “BrandAMP” portal. As shown in this figure, users can earn and redeem points through the incentive catalog. In this example, ads tease the purchase of last year's styles with points, and sample questions are provided that feature incentive catalog products and tease a sale. Once in the catalog, the users are upsold current styles and users can earn additional points for answering sampling questions.

FIG. 11 provides an example of an ad placement report within the “BrandAMP” portal. In the ad placement report, each ad, target, and custom context is evaluated for effectiveness. In this example, the ad placement report can be viewed by venue, by context, by relevance, and/or by action.

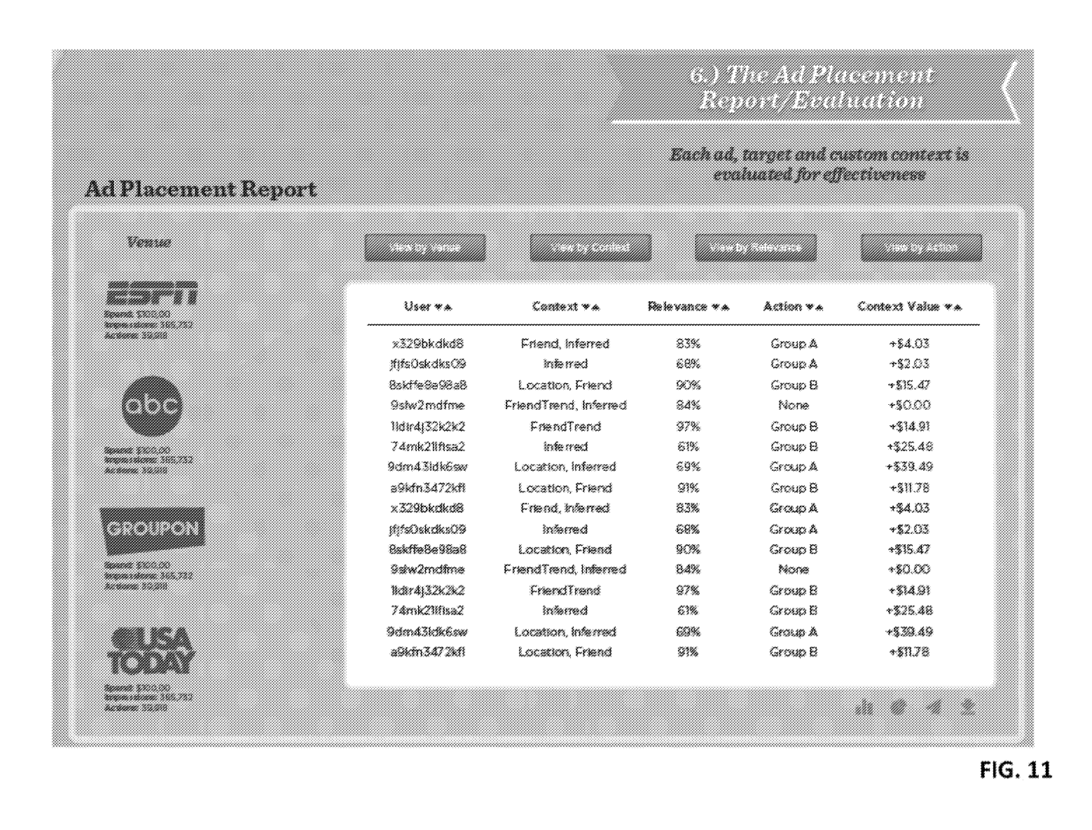

FIG. 12 provides an example of a redemption report in accordance with the “BrandAMP” portal. The redemption report shows the catalog redemptions on a cash or points basis. In this example, the redemptions can be viewed by product, by promo, by cash, and/or by filter points.

In accordance with one or more embodiments of the present application, options are provided for receiving user actions that are organically driving at least one aspect of how advertisers may pay for at least advertising and/or sampling. Advertisers desirous of paying for advertising more with “goods” or merchandise, (or related product value) instead of “cash” can be the assumption baseline. Hereinafter, various items, referred to herein generally as “barter,” include but are not limited to: “credits” for goods, wholesale or retail (such as “coupons” or certificates or other numerical credits or barter/scrip); or older goods, such as “last years unsold items” from one or more affiliates; otherwise less desirable good relative to new retail items; and premium items, such as merchandise exclusive to preferred individuals/accounts.

In at least this interwoven and critically self-informative embodiment of the present application, advertisers are desirous of reaching targeted users with information, questions and/or opportunities: hereinafter, all such will be called “ads.” Further, advertisers, alone or as a group of affiliated brands/entities, may be desirous of using as much barter as possible to acquire their ads. The barter not only can have the likely benefit of having a lower cost per retail “dollar” value ascribed (based on actual cost of goods at a given time as valued by the advertiser and/or others), but also can allow once “marked down” items to remain selectively at a full retail ascribed value allowing the enormous advantage of $100 in cash value ads to be acquired with $100 in barter.

In at least one embodiment, not only can goods be “moved” in this effort that otherwise required full or partial loss (such as “mark downs” and other value reductive inventory practices), but goods can potentially never be separated from their appropriate retail price, in the eyes of the public, even if old or close out. This aspect, in an embodiment where barter provides related goods/services from advertisers (and other commercially associated entities), can be used to provide a pool of redeemable items preferably available to (including but not limited to) the very same individuals who may be targeted for advertising acquired all or in part for providing those goods “to the affiliated redemption catalog” of the venue/membership.

The present application includes processing for a measured level of interest correlated relative to one or more groups of users. Such level(s) of interest, or interest factors, can be used, at least in part, to inform advertising purchasing options available to a given advertiser(s) at least on one respect: the amount and/or type of barter (and/or terms ascribed to the barter) can be impacted directly by the interest factor(s) derived relative to user interactivity. Herein, the primary interactivity referred to can be relative to interest in the redemption catalog items.

For example, interest in last year's Ray-Ban sunglasses at a price of $500 (or 500 points, to maintain preferably the retail-to-credit reality and impact/impression) can be a hot item that provides user interest data by virtue of at least user behavior around the item if not actual redemption, leading to a direct impact by computer managed software on the ad purchasing interface controls available for Ray-Ban ads. Further, by “sweetening” their incentive-catalog offerings, Ray-Ban can receive user accrued points related to the users' interactive experiences (such as interactive with ads) for more premium barter such as new items or certificates for retail use at points of purchase, and other current merchandise/services that can have more direct cash value impression to users. By providing new 2014 Ray-Ban sunglasses as a redemption item to at least some users (whether targeted for such or not by the advertiser), the system can correlate increased interest in such items, leading to an advantage to, for example, Ray-Ban's ad buying options. In this example, the interest in the premium items and coupons for redeemers to acquire (in one example as a “limited time redemption opportunity for high point acquiring users”), can inform system computing to allow Ray-Ban to purchase their next $500,000 in advertising at 50% barter and 50% cash, instead of just 40% barter, for example, which it was previously offered.

Herein, the advertisers can be greatly incentivized to enhance the goods and value of their redemption catalog offerings in order to receive more of their advertising based on retail priced (or otherwise valued agreeably) goods, and/or barter. In one or more embodiments, as an advertiser places an order for ads, their “blend” of cash/barter might be displayed. This, in at least one embodiment, can be immediately variable based on the category(s) of barter (provided via a system interface options) they provide. For example, by upping the order to include “50% category A year 2014 model goods” from 25% such goods, the advertising purchase “slider” (options) were affected, allowing up to 50% of the ads purchase to be barter based.

Thus, advertisers can use computer-managed incentive to make the incentive catalog better, and to improve at least the effect on their cash outlay relative to ads. In at least one embodiment, targeted users/groups can be designated as a system option provided for access to redemptions as a premium user (or type) targeted by the advertiser(s). Indeed, the user of barter in this way might be as targeted and controlled as the targeting of other information related to the ads themselves.

In one or more embodiments, the line between redemption catalog and ads is blurred, and, in at least one embodiment, at least partially eliminated. The feature of redemption catalog items, and the information framing access and context for those, may become all or part of what is considered ads within the venue. In this way, the incentive catalog allows users to acquire goods/services all or in part with points (incentives), and can become an e-commerce incentive venue for purchasing older incentive driving goods, and new retail items as well.

In one or more embodiments, the interactive behavior and permissions of users (including access to and/or user of personal information), can affect not only the amount of incentives they receive relative to barter, but can also impact one or more barter blend ratios ascribed to them, as blend relevant users. For example, a user providing access to Facebook “friends” (for user in targeting ads to him and/or to others featuring information related to the user) can, for some actions, receive amplified incentive points redeemable for goods entirely. Further, goods that are not simply incentive goods, but new premium (retail) goods, can be provided for 70% cash 30% credits, for this one user and potentially for this one transaction only, as a way to reward valued user behavior, (including access and permissions) relative to goods that are typically only available for cash. In at least one embodiment, cash value related to these user behavior and/or permissions, or their value otherwise determined, can be created from their information to allow for discounts on items that may not be provided by the featured items' brand itself, but by the venue or affiliated entity providing (or directing) value derived from the user behavior (such as permissions, information, access to data, or agreeable use of data such as preferences).

Thus, one or more embodiments of the present application can be a real-time “blend” management system, determining updated barter/cash options for acquiring not only ads (for advertisers) but goods/services for users. Each “account,” be it advertiser or user, based on their providing system/venue valued information and/or options (such as items for the advertising brands), can be not only updated continually, but potentially reevaluated relative to priorities of the advertiser, and/or venue priorities and/or user value, at potentially every point in an interactive process. Thus, for example, the “blend” Ray-Ban can be provided relative to the media provided to a user, Julie, and can be either set at 50/50 or potentially uniquely modified (like the stock market) to 47/53, based on correlated data pertaining to Ray-Ban and/or Julie at that given point in time. Julie can be given the opportunity to “redeem” or partially pay with barter credits (the incentive points accrued) based on a correlated value of the brand to her and her to the brand (and/or other venue valued aspect). In this example, Julie is offered the glasses for 500 points, whereas another user, John, at that same time, is offered the same items for 250 points and 250 cash. In one or more embodiments, this may be due to his interactions, his permissions, his accrued points or any other “John” relevant value aspect known to venue computing.

In another example, John can in one configuration be solicited to provide information and/or permission(s) to trigger a promoted price or value for him, such as allowing access to his preferences for at least some others users in order to allow the glasses to be acquired for 500 points, with no cash blend. In at least one embodiment, John can “purchase” points to acquire this option as well, by providing limited permissions by way of venue controls, such as agreeing to receive and/or provide media, or responses, or data, within an agreeable range, in order to advantage his current need.

Thus, the system can be a continually soliciting system of ongoing and/or limited access to information (from the users), and a continual barter catalog enhancing engine driving the merchandising of the catalog relative to users, individually, in groups, or otherwise, based on priorities ascribed continually to advertisers featured, and/or an advertiser featured relative to aspects of the users interactive with their information (and/or items) or solicited to do so.

In accordance with at least one embodiment of the present application, an engine driving accessible information and permissions and valued goods/services to the venue is provided by creating a barter/incentive based platform between users and providers (brands/advertisers), where each can be evaluated and rewarded relative to each other and what they are bringing to the table at that particular point in time, or that particular interactive opportunity. As preference information and better goods can be continually sought to enhance the venue's interest to users, brands can further sample users and affect their opportunities individually or as a group(s) at any point in time. For example, Calvin Klein needing to test interest in a new style can provide a unique barter blend opportunity to Julie, as a targeted sampling user of value, that at that time in her interactive experience would not have occurred without the priorities provided then (or relative to then) by the brand (or on behalf of the brand, by an agency or related brand representing media buyer associated with the Calvin's ads). Thus, an interdependence of criteria and/or information provided by participating parties, including user(s) and advertiser(s) affecting the value options, are available to each in relation to at least barter/incentives. Below is another example involving users Julie and John.

In this example, Ray-Ban updates their parameters related to the goods they are providing to the BrandAMP incentive/redemption catalog. Ray-Ban includes, in this example, 20% more “category 1” (highest valued) goods, and styles in category 1 were previously input to the system.

Equity between styles is allowed, here, where if one “category 1” style is exhausted, the other “category 1” styles will fill in for the balance of honored redemptions. Ray-Ban uses the ad placement interface (their agency in this example) to further allow user meeting levels of criteria to buy certain new goods, identified as “category 1-P” under special conditions (part cash, part points), with “category 1-P2” goods having the restriction of being retrievable only at the retail locations listed (e.g., Sunglass Hut).

Continuing with this example, Ray-Ban has purchased, based on these parameters, $500,000 in targeted advertising and preference sampling of “BrandAMP” users, based on the rate card for such advertising and the automatically calculated barter blend of 50/50, cash

to goods, with both the goods and the targeting parameters of both redemptions and advertising provided and acknowledged. Julie has more than 10,000 points accrued, as a result of her interactions. These interactions included a certain number and type of permissions to allow her to receive ads and answer questions, as well as her personal information being used to a prescribed level in ads (as context) sent to other users. In this example, Julie is a “category 1-AX” target by Ray-Ban (and others), and she is a different target category for selected other “BrandAMP” advertisers. Further, Julie is desirous of redeeming Ray-Ban sunglasses. As a previous buyer of Ray-Ban via a preferred “BrandAMP” opportunity, Julie has special access to the “category 1” redeemable goods of Ray-Ban along with others in the “category 1-AX” group.

Users in the Ray-Ban “category 1-AY” group (based on system grouping in relation to at least some Ray-Ban criteria), can redeem “category 1-P” goods, which include the “category 1” goods in this case, based on a different scenario, namely cash plus points.

In this example, the blend available to such users is based on the user's value to Ray-Ban by system categorization, and/or their system valued behaviors, such as, in this example, allowing “BrandAMP” valued access to their social associations and preference information.

Continuing with this example, Julie can be valued differently from John, by advertiser Ray-Ban. Further, Ray-Ban may have purchased ads in relation to targeted user(s) at a new barter/cash blend as a direct result of two factors: 1) a degree of redemptions using accrued incentive points of certain Ray Ban items/goods, and 2) Ray-Ban's revised parameters allowing more year 2014 (new) goods to be included in the redemption catalog than before. Specifically, these two factors in the current example, provide 1) increased redemptions of Ray-Ban goods by one or more group(s) in this example including several targeted groups that impact potential barter blend more than at least some other group(s) based on system criteria; and 2) Ray-Ban (via their ad agency, in this example) allowed for 20% more year 2014 goods to be included in the redemption catalog (as fulfill-able commitments to ship by Ray Ban via Redemption Reports with shipping addresses of users, as items are redeemed).

In this example, the actual Styles of 2014 goods are indicated, from previously provided information. A preapproval of the buy can occur automatically by system software, with the potential of a venue review of the new parameters from Ray Ban, to ensure that the revision is indeed within the system desired guidelines to enable the computer managed revision to the barter blend, used to purchase (in this case) $500,000 in additional Ray Ban targeted ads.

For this example, Ray-Ban goods affect overall net cost of advertising for Ray-Ban based on meeting “BrandAMP” criteria affecting at least barter blend(s) for this advertiser. “BrandAMP” member users Julie and John, based on information they provided, have special access to Ray-Ban premium goods, though based on different computer-determined incentive scenarios, factoring points, permissions and actions of the users in relation to other criteria, including advertiser criteria.

In at least one embodiment of the present application, in addition to the tandem affect of user permissions and information relative to rewards (such as points) provided to users, another operable aspect includes user free-form verbiage, such as typed or voice-provided input (or otherwise supplied information) that represents a user's response to a request for personal information.

Herein, a system determination of value of user input can include keyword and/or phrase determination. For example, system markers are algorithmically correlated with the user-related verbiage to determine at least one value aspect of the words to the system.

Variables can impact a visibly growing point reward as the user provides the information. Examples include (though are not limited to): determination(s) of value to advertisers and/or data purchases; determination(s) of value in relation to system-determined psychographic issues such as likely “truthfulness” of the information; a categorical value, such as sexually related comments providing increased point accrual (per word for example) related to less personal information such as a sporting preference; and brand centric comments having their own categorization(s) to encourage brand related feedback of advertising and/or other brands among many other such options.

Thus, for example, as a user, “Pete,” provides the information “I really like to ski, I like to date, and drink beer. I stay up late and watch David Letterman every night.” This information can be processed to provide, in at least one embodiment, a related (including a substantially immediate) effect to a point accrual value that can be allocated to the user and/or allocated once a final “submission” instruction is provided by the user providing the information.

In at least one embodiment, the system provides a user controlled platform to provide and allow the use of personal information, access to information and/or media for advertising provided to and/or featuring that user. In one or more embodiments, this can occur on the site providing the profile input prompts to the user and/or on linked or partnered sites, wherein “signing in” to those sites is made known to the present system by the users by a general default permission or by other instruction once, more than once and/or each time visiting such partnered sites.

In one or more embodiments, points accrued can be used by users to redeem goods, at least some of which can be provided by advertisers all or in part to reach that and/or other users of venue(s). Interactivity relative to those advertisers' brands (and goods/services) including interest in redeeming those goods with accrued points, can, at least in part, be weighed by system computing functionality to update and/or determine a barter ratio related to advertiser payment for advertising and/or user sampling (including preference sampling).

Barter “ratio” or barter “blend” relates at least in part to an advertiser's system permission to pay for advertising and/or sampling media ordered (by or on behalf of the advertiser) using some form(s) of goods and/or services otherwise sold by the (and/or on behalf of) the brand through other vendor/sales options for cash, typically. For example, a brand can have a style(s) of sunglasses that was sold last year for $500 per unit, retail. In this example, 1,000 pairs of these provide $500,000 in normal rate advertising and/or sampling media from via the present system and method, when implemented as an interactive advertising placement platform. Through unique determinations of this method, in at least one embodiment, the interest of users in the brand can be one variable that can be weighed in determining how much of this product can be used to purchase advertising and/or sampling. Further, what ratio of the media cost to an advertiser may be paid with such goods, can be determined. For example, popularity, real or anticipated by system computing, can limit or accept an ad purchase of $1 million; though by default permission or additional permission for the advertiser, require that 50% of that 1 million be paid in cash with the other 50% being based on the value of the provided goods.

Herein, value can be added to the goods, old or new, gift certificate or close out merchandise, at the full retail value to maintain brand integrity for an advertiser, avoiding denigration of product value even if discontinued. Further, in one or more embodiments, full original retail price can be the sole basis for redemption, thus a $500 pair of glasses can have a 500 point, or 50,000 point (if based on cents and not dollars) value to maintain and reinforce product value. Indeed, retail gift certificates for new goods can be more popular than last year's featured styles that did not sell and/or were returned from sellers.

To this point, in one or more embodiments, users can themselves and reciprocally “enrich” their redemptions. Thus, premium goods can require a cash/point blend to acquire, bringing “sale” and “redemption” into a variable and value-weight process with all purchases. Thus, for example, tickets to a popular rock star concert may require 70% cash and 30% points, whereas last year's sunglasses may be redeemed entirely for points.

Although it is not necessary that retail list price be a basis, retail list price can be appropriate for a brand integrity engine to drive advertiser value.

Further, one or more embodiments relates to novel applications to sales and/or auctioning venues. Thus, for example, when a product is put on an auction site for $400, the listing “user” can function as the advertiser (herein “sponsor”), and indicate (or be open to later approving) an all or partial “point” payment for their listed goods and/or services. A new value-based barter system can thus be generated, allowing in at least one embodiment for user interest to indicate bids that directly and/or by system determination, a cash plus points purchase (or transaction) scenario.

Further, a provider of goods/services on a venue(s) can benefit from sale of items, accruing value by acquiring other items for points and/or cash in an advantaged scenario to simply bid against cash offers, or pay a listed cash price. For example, a used television listed by a user for $500 cash can begin or be updated to be purchasable with points. A point acceptable blend/ratio and/or value can be provided on the sales (and/or auction) venue, as information featured by the listing user (seller).

In at least one embodiment, new versatility can be created as all or part of the purchase may be “best bidder” determined with cash and/or points (accrued by bidders). Thus, for example, the $500 item can have a bid for $350 cash, and another high bidder at $700 points, even exceeding the “buy now” cash price featured, for example if one were ascribed. Thus, new purchasing and/or bidding latitude can be created with this new incentive point based currency.

In one or more embodiments, system of exchange can be created without brand name advertisers at all, as users, their media, their offerings, and their credits (and/or cash) are factored by system computing to facilitate transactions. For example, users as sponsors and users as providers of information meet on new common ground, an auction or sales item offering associated with an individual user/seller can be promoted to a user in relation to a context (such as social and/or preference or other relevance enhancement) that the system determines, at least in part, in relation to the incentivized permission(s) the targeted user has provided.

Further, in at least one embodiment, a user can receive a promotion for an item offered by an individual user/seller (such as on Ebay and related services) in the promotional context of another user who is relevant to that seller and/or targeted user receiving information about that seller. For example, another user who acquired an item from that seller may have provided permission to allow his name and/or media and/or comments and/or history with that seller, to be shared with others, in exchange for incentive(s) such as points. Thus, herein is disclosed a system that in one or more embodiments can feature other user-sellers, be they individuals offering one or more items for transaction, celebrities promoting, and/or larger vendors offering more broadly sold goods, including brand name vendors. The commonality includes system managed rewards, relative to personal information being used to promote transactions from sellers (and/or sponsors). In at least one embodiment, those sponsors featured in the “redemption catalog” discussed above represent an example of these sellers, with the “redemption” of an item constituting a form of purchase of an item that was used to acquire all or part of their sponsored media order(s), such as unique social context advertising targeted to information providing user(s).

In one or more embodiments, interest in an item(s) by way of user redemptions, purchase and/or feedback, can impact, by system computing, the barter ratio (such as points) and/or amount that may be employed in acquiring, licensing and/or otherwise participating in those desired item(s).

Such a barter system involving points that can come from rewards, such as disclosed herein in one or more embodiments, can be directly or tangentially used to invest in projects via crowd-funding venues, used to acquire pay-per-view media, or other media, and can be used to pre-order products/services that may have to be first determined of interest from such interest, before actual providing of finished product can occur.

The present application includes a venue that employs mutually weight permissions vs rewards methodology and system, reciprocally (in one or more embodiments) impacting the media purchasing options of advertisers, including what percentage of their consummated media orders can be paid by provided and/or fulfilled goods (e.g., provided to the media provider and/or fulfilled directly on behalf of the advertiser to at least one user).

For example, a user of the platform named Pete adjusts two “toggles” to allow more access to his personal information and or media, it is illustrated how this can impact both his actual (or likely) incentive point accrual potential, as well as the tandem influence these setting levels can have on ads he may receive and or the ads other may receive based on those permission levels. Also illustrated, by the granular setting accessed by the left arrows on the categorical “bars” featured in the left and right columns, are additional controls that can affect the accessibility of personal information for advertising and sponsor valued interactions; this also can impact, with each instruction, the “total reward factor,” or volume by which PETE might earn incentives: more incentive points potentially for providing more access and more sponsor-valued options relative to Pete's information, contacts and/or media, (and potentially other values associated with “Pete”) as well.

In one or more embodiments of the present application, a cross venue and/or cross platform advertising purchasing and fulfillment system and method is provided. In at least one embodiment, this advertising system includes a user rewards system that not only provides incentive credits (such as points) to users who provide permissions and/or interact in relation to sponsored information, but a user rewards system whose users impact the actual ad purchasing dynamics from sponsors at least in relation to the percentage of goods/services they provide as payment for sponsored information being provided to users.

At least one embodiment includes computer managed determination of social context advertising, including branded advertising featuring the names and/or media associated with other user(s). To acquire these relevance enhanced advertising options, the present system can engage sponsors in providing incentive goods/services as an aspect of their advertising purchases. The system can further use these goods/services to provide redeemable items to users, who provide permissions to access social context information associated with their own name (and/or preferences and/or messages and/or past actions), which is used to generate the very ads that system sponsor(s) have purchased and targeted (with this enhanced social relevance) to system user(s).

In one such example, a user whose name and/or preference (and or media) is incorporated into a sponsored message for “skateboards” generated and transmitted to another user, can cause both the user whose names is featured and the user who receives the sponsored message to receive incentive points. This can occur entirely (though not necessarily) while at least one of those users is offline, with the offline user finding an enhanced incentive point total in his “account” when he signs in again. In this example, the relevance of the two users to each other is clear, as they are “friends” or other contacts of the other, at least one of them having the other in a “user group of interest,” directly or by virtue of a relevant trait, preference or user aspect (of one or both of them).

In at least one embodiment, users interacting on a plurality of associated sites and/or services accessed through computing devices, including laptops and wireless devices, can provide information to, receive advertising and/or sampling questions from, receive incentive points in relation to, and redeem from the parent venue managing the advertising and user rewards system.

Users provide information, in one or more embodiments, that can provide a basis of correlating interest in a sponsor's product(s) and/or service(s). One way this interest can be demonstrated is by way of actual user redemptions from a catalog aspect featuring actual products and/or services of sponsors. One or more of these sponsors can provide such good/services to the catalog as an aspect of their targeted advertising (and/or preference sampling) orders.

In such a user (consumer) driven advertising barter platform, the user's redeeming certain items from the catalog with their incentive points accrued, can be, at least in part, factored to determine a ratio of cash-to-merchandise that an advertiser (and catalog item provider) can experience in relation to their desired ad buy.

For example, a luggage maker (sponsor) places an order for $100,000 in advertising, allowing him to target a volume of users who are interacting (or will be) on one or more interactive destinations or services, via home and or wireless computing device. This sponsor indicates in his order a desire to pay for as much as 100% of his advertising with specific goods, which are namely 100 luggage sets with a retail price of $1,000 per set. These sets are, in this example, leftover goods not sold from the previous year representing discontinued items that have been replaced with new styles.

In at least one embodiment, imagery (media) and information about the redeemable goods can be provided as at least one listing in the catalog. User interest, which can be demonstrated by at least actual redemptions and/or other feedback provided, can provide an actual and/or projected basis on which to determine how much of the requested 100% “barter” media order may be in fact paid with these goods. In other words, the barter blend that the system determines can be honored and/or offered.

In one example, a swift redemption interest in the goods allows for system programming to ascribe an 82% of advertising buy “with barter (goods)” based on that retail prices and at least the interest of users that indicates that the offered goods will be redeemed fully by users within 3 weeks (for example).

In a more conservative example, the luggage maker is invited to pay 100% cash for this advertising, until actual redemptions of the older goods offsets this cash price. For example, if $50,000 in retail luggage is redeemed (and fulfilled by the sponsor and/or another fulfiller) within an agreed time frame, the final media bill for that advertising, which reached over 4 million targeted users over 12 sites and services in this example, is $50,000 cash and $50,000 of the listed luggage, in this case.

In this scenario, the luggage maker's next media purchase was ordered in relation to “better” goods, namely retail gift certificates to his stores for the new styles of luggage. User's interest in these newer items, even if having to be redeemed at actual retail locations, was more intense than for the close out goods, thus the final ad placement fulfilled with retail price based merchandise was over 80%.

The present system, in one or more embodiments, suggests all barter, old and/or new, to be based on retail price to maintain brand integrity as a benefit of the present system. However, the options for system computing managed (and/or subjectively determined) price bases of goods, including cataloged goods/services, is optional and may include pricing (or discounts, or improved cash/barter scenarios to the redeemers) that is other than strictly original retail price based. Conversely, in one or more embodiments, premium good redemptions can require users to “purchase” with cash, all of part of the item. Thus, for example, a sponsor may have paid 30% of his advertising order with cash, while the items used to pay the other 70% may have been offered as “premium” items to users, requiring them to pay (for example) 20% of the item's featured price with cash, and 80% with redemption points to acquire it.

In at least one embodiment of the present application, the nuanced management of user provided information, targeted advertising to at least some of those same users, and a redemption system and catalog are provided and function interdependently. The users can provide degrees of access to personal information and/or media for use in advertising, in return for degrees of incentive points. These points can relate to goods/services provided by advertisers, who have acquired advertising that is provided to at least some of the point accruing users as payment (all or in part) for the advertising.

This advertising can be generated and/or targeted based, at least in part, on the information provided by the users for which they were rewarded. The use of the incentive points by users, relative to the goods/services of the respective advertisers in turn can directly influence the amount of advertising that may be acquired, all or in part, with goods/services.

Thus, in one or more embodiments, a barter management system is created that can be user-driven, and created to elicit accessible user information that empowers advertising, which itself can be generated and purchased in direct relation to the information and/or redemptions of goods/services, specific to the advertisers who have at least offered goods/services to a linked/featured (accessible) redemption catalog, by users.

Thus, in one or more embodiments, highly willing users can be created through incentives and advertising transparency, allowing them to share in the value of the use of the personal information and media by way of the incentive points that can be redeemed. Further, advertising of increased relevance to them, and/or other users, can be generated by this increased access to personal information and media. Further, enhanced value to brands can be created by users redeeming their goods/services, offsetting cash costs for the improved media targeting and relevance products delivered to system users.

Further, brands can generate new future clients by way of redeemers of their items, who otherwise might not experience their goods/services, and who also represent ideal preference and feedback targets for sampling efforts the system can provide. Further, as older, unsold or returned (close out) goods, for example, can be offered by sponsors to the catalog, (within a range of acceptability) the point system can protect retail value of their goods, allowing them to be redeemed for points, all or in part, based on original retail pricing, providing brand-integrity protection over the typical “dumping” of goods at extreme discounts via selling sites, factory outlets or damaging mark-downs, sales and liquidators.

In total, the present system and method, in one or more embodiments, can provide an confluence of interdependent tools for driving user willingness and contentment through transparency, driving brand awareness and integrity, while creating a platform for advertising and sampling of increased relevance, targeting and receptiveness (by users) quality.

The present system managed and variable barter barometer system of the present application, in one or more embodiments, can allow for computer determinations of requested, pending and/or future advertising orders in relation to how much of the order can be paid with certain goods/services. Further, system management based on variables including but not limited to availability of items, status of the users (such as “premium users” who have met thresholds of performance), and popularity of items, can also influence the cash/points “blend” that users may be offered and/or find they received, in relation to their purchases and/or redemptions.

Indeed, both the cash/points blend, and cash/barter blend that users and sponsors (advertisers providing goods, for example,) may be managed in relation to a single piece of luggage, for example. Who is providing it and/or who is redeeming it, and a plethora of system manageable variables specific to the item itself, are among the system managed options that empower the ways advertising can be sold, and users may be rewarded in one or more embodiments. Thus, if a certain brand is desired as a “sponsor” to improved the overall system (such as based on a subjective and/or programmed determination that their goods would improve the catalog overall), the overall sponsored media sale to that sponsor can be, at least initially, substantially or completely purchasable with the offered goods.

Later, in at least one embodiment, actual interest and/or changing dynamics, such as an abundance of once more desirable goods (and/or services), can change the “blend” of cash to merchandise that the sponsor and or users are offered in relation to the exchange of those item(s), such as those featured in the linked catalog for redemption and/or “advantaged sale” scenarios.

In one example, an advertiser, who is also providing goods to the redemption catalog for users to acquire (at least in part) with accrued points, has placed a media order targeting users for sponsored information. In relation to this placed order, user's interactions, such as redemptions, relative to at least this advertiser's cataloged goods has a system (computer) managed affect on that media order and/or future media order(s) at least in relation to the barter blend, which refers to the percentage of goods/services an advertiser can pay for a media order, or other desired product, the balance being paid with cash.

In this same example, new versatility in managing barter blends for both users and sponsors, potentially (though not necessarily) allowing retail prices to remain constant, as the “blends” change; including the option of even exceeding 100% in instances where ad sponsor and/or user desires premium level value, requiring more barter and/or cash to reach that threshold. For example, Lady Gaga tickets may require 150% of their cash price in points, to redeem. In another example, a sponsor may need to provide 50% cash and 120% trade (retail goods) to access certain user(s) and or premium services offered.

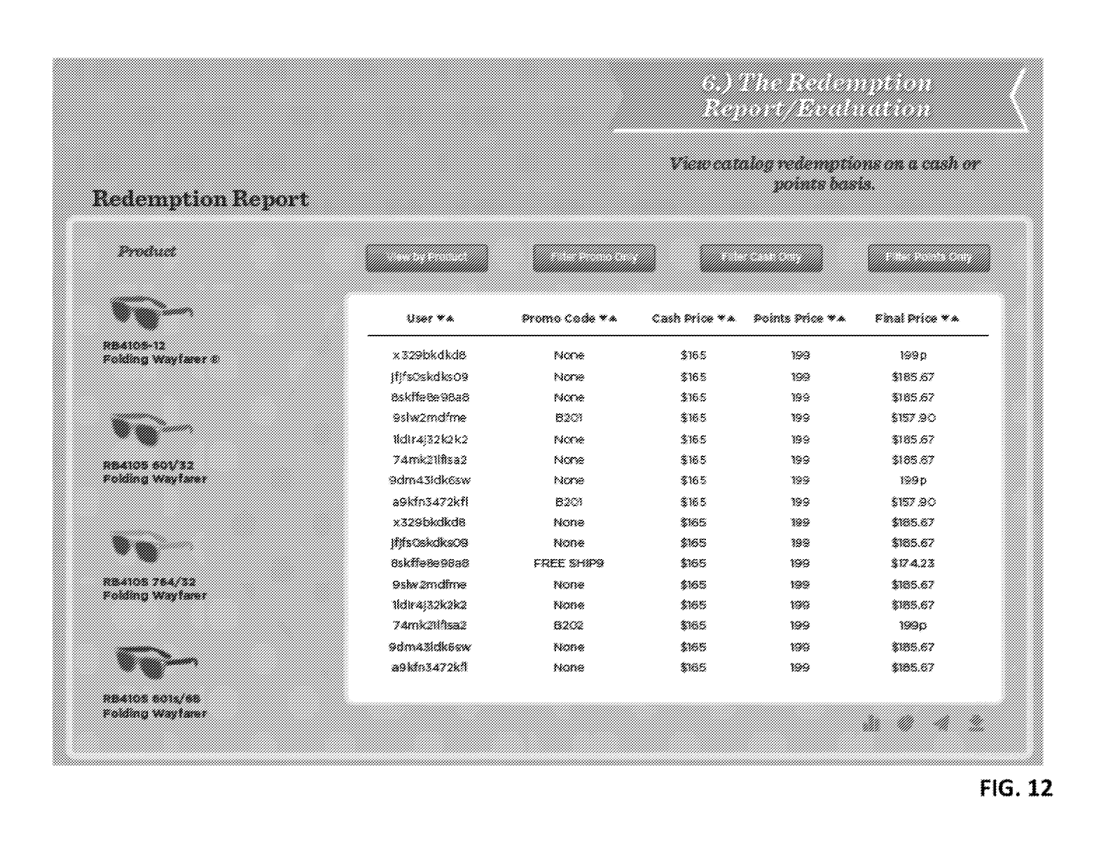

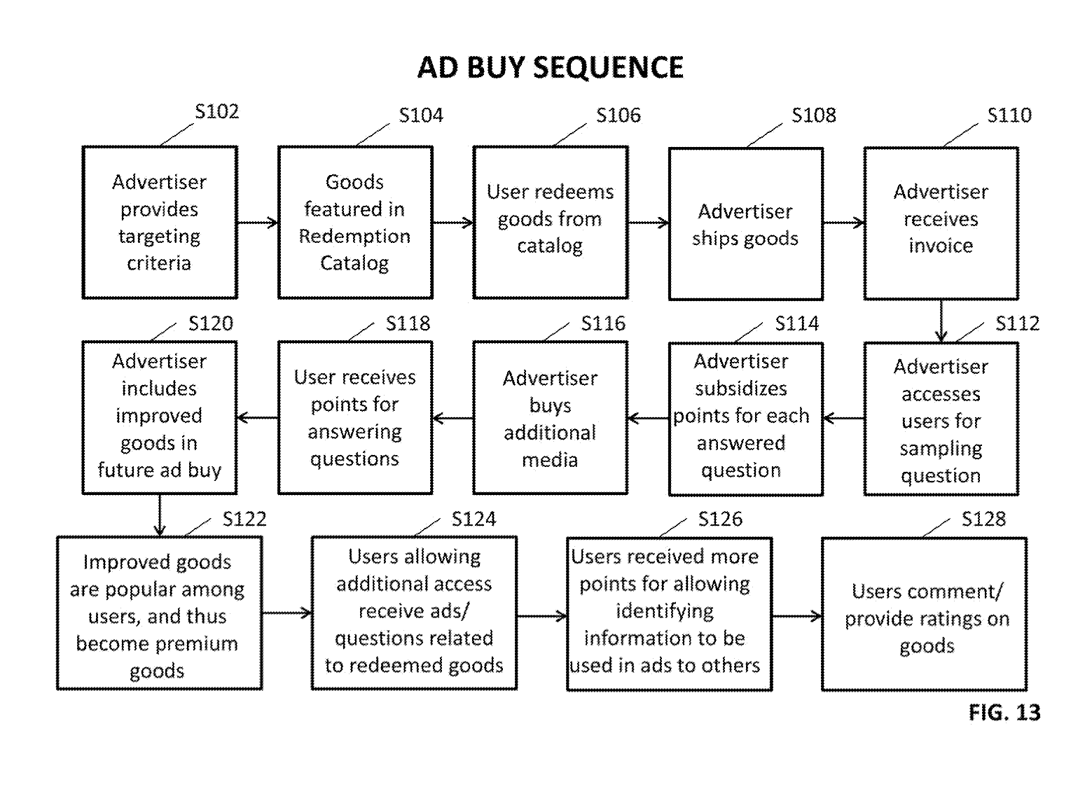

FIG. 13 is a flow chart illustrating an example of an ad buy sequence in accordance with one or more embodiments. In this example, advertiser A first provides targeting criteria including gender/age (e.g., male 25-35), location, preferences, social networks, sites visited, and past redemptions (S102). In this example, there is a $1 million ad buy with a request for 100% with a group of goods (“A1”) featured in the redemption catalog. The ad is limited to three partner sites (services) and the ads include 50% preference sampling. After advertise A provides the targeting criteria, the group of goods (“A1”) is then featured in the redemption catalog (S104). Next, 37,920 users redeem goods from “A1” from the catalog totaling $390,281, consuming 39,028,100 system points (S106). Advertiser A then ships these goods to the 37,920 users (premium users pay no shipping, having used points to pay for all shipping, for example) (S108). Advertiser A then receives an invoice for fulfilled $1 million in advertising, for only $609,719 cash (offset by retail price based redemptions) (S110). Advertiser A then accesses through ad buy the 37,920 users for sampling question(s) (for extra points to users) about their new line of product, learning from interested users what colors and/or styles will be most popular if made (S112). For instance, the users meeting certain criteria are asked a color question, and others meeting other criteria are asked a style/design question. Advertiser A then provides an additional 379,200 in retail price goods to subsidize 1,000 points for each answered question to the redeemers (S114). The system charges based on variable weighed determinations an additional 20%, or $75,840 in cash, to deliver the sampling questions to the users who redeemed goods.

Continuing with this example (in reference to FIG. 13), Advertiser A then buys additional media (S116). The system programming, based on the past redemption performance, allows an approved blend of cash-to-barter of 40% (40% of retail goods). If redemption volume improves, the next ad buy can be adjusted accordingly. The users then receive points for responding to the sampling questions, most of which are used for items from other sponsors in the catalog (S118). Next, Advertiser A includes improved goods (group “A2”) in future ad buy, namely retail gift certificates (S120). This allows for 90% of the ad buy to be paid with “A2” goods.

Subsequently, the users find the “A2” goods to be very popular and these goods become premium goods (S122). Based on demand, users find that these goods, once available for 100% points, now require 20% cash and 80% points to acquire, based on the posted retail prices. Users who have provided system settings allowing their feedback and/or redemptions to be used as rewarded information used to help other sponsors improve their advertising, find that they are receiving some ads and questions now that related to products/services deemed synergistic (e.g., similar and/or related) to the redeemed “A1” goods (S124). Other users receive ads featuring the names of some users out of the 37,920 redeemers and even the photos of some of them. Even a few of them receive ads featuring comments/posts by these users, related to the “A1” goods and/or related to Advertiser A. These users are rewarded with more points more heavily, for allowing such additional personalized info/context to be used in ads sent to others (and/or in helping to target more sponsored information to them directly) (S126). Users then comment and/or provide “ratings” on the redeemed “A1” goods and how they were fulfilled (e.g., timely, and nicely) (S128). These influence at least one factor weighed by system computing in determining present and/or future barter blend(s) (e.g., percentage of sponsored information ordered that may be paid for with “A1” and/or related goods by Advertiser A).

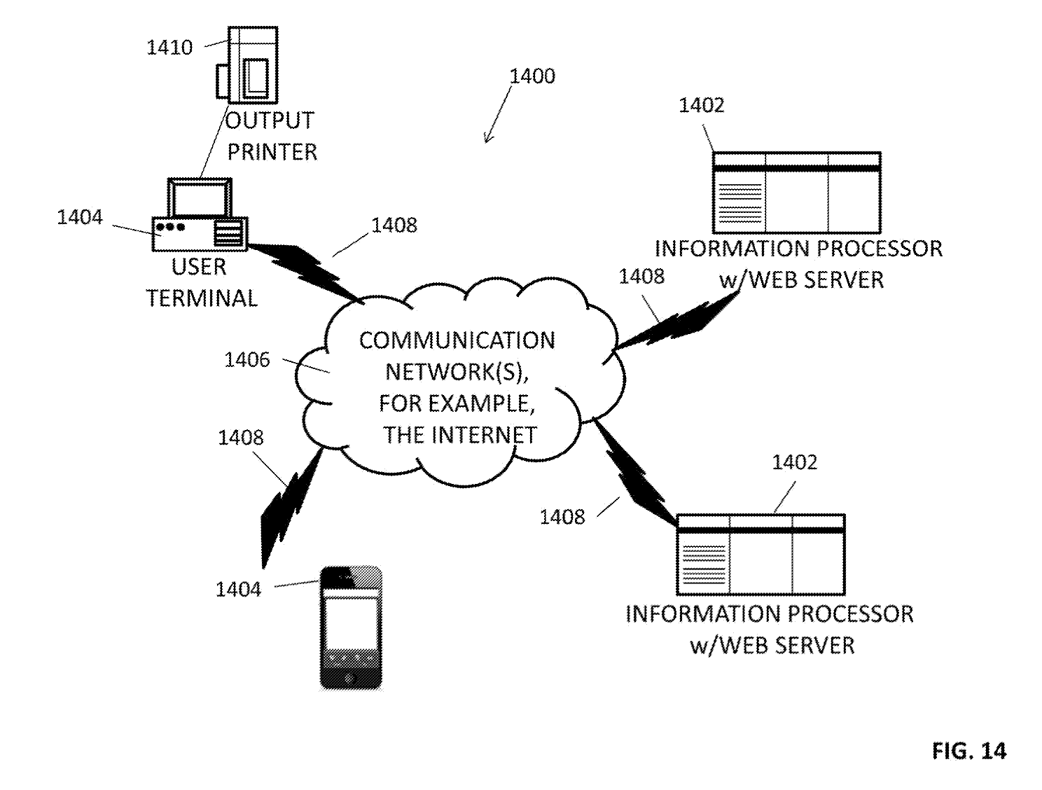

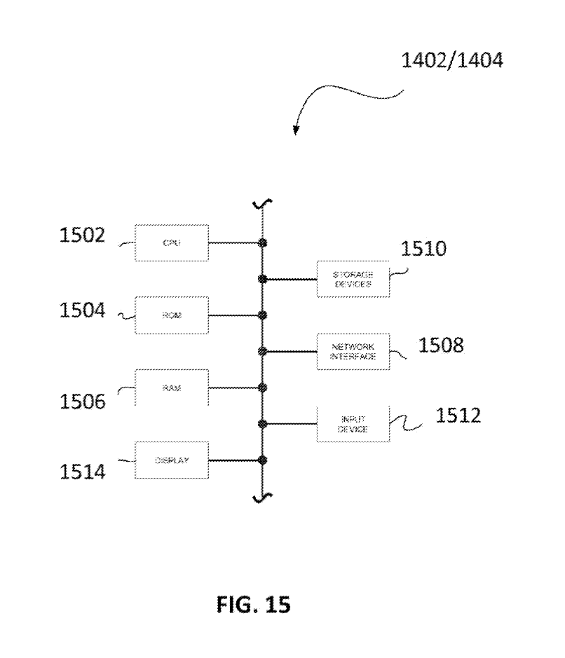

Referring to FIG. 14 a diagram is provided of an example hardware arrangement that operates for providing the systems and methods disclosed herein, and designated generally as system 1400. System 1400 is preferably comprised of one or more information processors 1402 at least communicatively coupled to one or more user workstations 1404 across communication network 1406. User workstations 1404 may include, for example, mobile computing devices such as tablet computing devices, smartphones, personal digital assistants or the like. Further, printed output is provided, for example, via output printers 1410. For example, output can be provided via output printer 1410 and/or other device (e.g., a display screen 1514 (FIG. 15)) of a confirmation of the investment of the second portion of the portfolio.

Information processor 1402 preferably includes all necessary databases for the present invention, including image files, metadata and other information. However, it is contemplated that information processor 1402 can access any required databases via communication network 1406 or any other communication network to which information processor 1402 has access. Information processor 1402 can communicate devices comprising databases using any known communication method, including a direct serial, parallel, USB interface, or via a local or wide area network.

User workstations 1404 communicate with information processors 1402 using data connections 1408, which are respectively coupled to communication network 1406. Communication network 1406 can be any communication network, but is typically the Internet or some other global computer network. Data connections 1408 can be any known arrangement for accessing communication network 1406, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User workstations 1404 preferably have the ability to send and receive data across communication network 1406, and are equipped with web browsers to display the received data on display devices incorporated therewith. By way of example, user workstation 1404 may be personal computers such as Intel Pentium-class and Intel Core-class computers or Apple Macintosh computers, but are not limited to such computers. Other workstations which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 1406. Of course, one skilled in the art will recognize that wireless devices can communicate with information processors 1402 using wireless data communication connections (e.g., WIFI).

According to an embodiment of the present application, user workstation 1404 provides user access to information processor 1402 for the purpose of receiving and providing information. The specific functionality provided by system 1400, and in particular information processors 1402, is described in detail below.

System 1400 preferably includes software that provides functionality described in greater detail herein, and preferably resides on one or more information processors 1402 and/or user workstations 1404. One of the functions performed by information processor 102 is that of operating as a web server and/or a web site host. Information processors 1402 typically communicate with communication network 1406 across a permanent i.e., un-switched data connection 1408. Permanent connectivity ensures that access to information processors 1402 is always available.

As shown in FIG. 15 the functional elements of each information processor 1402 or workstation 1404, and preferably include one or more central processing units (CPU) 1502 used to execute software code in order to control the operation of information processor 1402, read only memory (ROM) 1504, random access memory (RAM) 1506, one or more network interfaces 1508 to transmit and receive data to and from other computing devices across a communication network, storage devices 1510 such as a hard disk drive, floppy disk drive, tape drive, CD-ROM or DVD drive or other non-transitory processor readable media for storing program code, databases and application code, one or more input devices 1512 such as a keyboard, mouse, track ball and the like, and a display 1514.

The various components of information processor 1402 need not be physically contained within the same chassis or even located in a single location. For example, as explained above with respect to databases which can reside on storage device 1510, storage device 1510 may be located at a site which is remote from the remaining elements of information processors 1402, and may even be connected to CPU 1502 across communication network 1406 via network interface 1508.

The functional elements shown in FIG. 15 (designated by reference numbers 1502-1514) are preferably the same categories of functional elements preferably present in user workstation 1404. However, not all elements need be present, for example, storage devices in the case of PDAs, and the capacities of the various elements are arranged to accommodate expected user demand. For example, CPU 1502 in user workstation 1404 may be of a smaller capacity than CPU 1502 as present in information processor 1402. Similarly, it is likely that information processor 1402 will include storage devices 1510 of a much higher capacity than storage devices 1510 present in work station 1404. Of course, one of ordinary skill in the art will understand that the capacities of the functional elements can be adjusted as needed.

The nature of the present application is such that one skilled in the art of writing computer executed code (software) can implement the described functions using one or more or a combination of a popular computer programming language including but not limited to C++, VISUAL BASIC, JAVA, ACTIVEX, HTML, XML, ASP, SOAP, IOS, ANDROID, TORR and various web application development environments.

As used herein, references to displaying data on user workstation 1404 refer to the process of communicating data to the workstation across communication network 1406 and processing the data such that the data can be viewed on the user workstation 1404 display 1514 using a web browser or the like. The display screens on user workstation 1404 present areas within control allocation system 1400 such that a user can proceed from area to area within the control allocation system 1400 by selecting a desired link. Therefore, each user's experience with control allocation system 1400 will be based on the order with which (s)he progresses through the display screens. In other words, because the system is not completely hierarchical in its arrangement of display screens, users can proceed from area to area without the need to “backtrack” through a series of display screens. For that reason and unless stated otherwise, the following discussion is not intended to represent any sequential operation steps, but rather the discussion of the components of control allocation system 1400.

Although the present application may be shown and described by way of example herein in terms of a web-based system using web browsers and a web site server (information processor 1402), and with mobile computing devices (1404) system 1400 is not limited to that particular configuration. It is contemplated that control allocation system 1400 can be arranged such that user workstation 1404 can communicate with, and display data received from, information processor 1402 using any known communication and display method, for example, using a non-Internet browser Windows viewer coupled with a local area network protocol such as the Internetwork Packet Exchange (IPX). It is further contemplated that any suitable operating system can be used on user workstation 104, for example, WINDOWS 3.X, WINDOWS 95, WINDOWS 98, WINDOWS 2000, WINDOWS CE, WINDOWS NT, WINDOWS XP, WINDOWS VISTA, WINDOWS 2000, WINDOWS XP, WINDOWS 7, WINDOWS 8, MAC OS, LINUX, MS, ANDROID and any suitable PDA or palm computer operating system.

Disclosed herein are additional embodiments in accordance with the present application. In one or more embodiments, the present application relates to a system and method for interactive, computer implemented media fee determination.

In one or more embodiments, several variables can work in concert to allow relevance interactivity of networked users to affect whether advertisers may purchase advertising within a service based on the present application, and if so, how the advertising will be charged, including overall cost and/or options for payment. All of this can be included within a single venue and/or site, or across linked venue(s) and or site(s) and/or interactive platforms.

In one or more embodiments, incentive credits can be accrued by users in exchange for providing access and/or information, or other action(s) with programmed value(s) known to system programming. Additionally, these credits can be used all or in part to redeem goods and/or services of a range of brands, including brands that have placed or are desirous of obtaining advertising and/or other targeted solicitations, such as questions of users, including one aspect as preference sampling, or another as focus group data.

Herein, in at least one embodiment, the actions that user(s) take in relation to redemptions of goods can have a system managed impact on how much advertising the brand associated with those goods (or entities related to the brand) can acquire through the venue and/or how much of the desired “advertising buy” can be paid for with goods. Further, what goods can be used to acquire all or part of an advertising buy can be further influenced by system evaluation of at least user interest in the goods offered for redemption through the redemption “catalog” aspect of the system and method.

In one or more related embodiments, the present system can provide a computer managed barter manager, driven by interactive user interest. For example, a brand may have goods of a certain categorized types, which will be called “A.” Herein, these represent premium, new items. Another category of goods from this brand, “C,” are unsold retail items from last year's stock that are returned to the brand from vendors. Such goods can include many items seen in factory outlet stores, for example, or mark down (discount) sites. Though there are potentially many categorized types of goods, based on quality, age or other value affecting aspects, the present example involves these two categories. It is worth noting that user information alone can provide all or part of the categorizing process based on redemption interest in the item(s) and/or direct feedback related to the items, whether solicited or otherwise.

In this example, the “A” and “C” goods are offered by the brand as payment for advertising. More specifically, in this example, the goods are provided as items within the redemption catalog at a “testing” threshold, to sample user interest in the goods and to determine likely redemption volume. The brand has placed a $100,000 order for specific, targeting advertising and preference sampling offered as ad placement products of a service in accordance with the present application. A week long testing period, with only $10,000 in advertising approved based on merchandise only as the means to purchase, in this example, determines that redemption volume likelihood. Based on user demonstrated interest, the system computing is configured to approve the ad buy as a maximum of 40% of “A” goods, 20% of “C” goods (all based on retail price for example) and 40% cash, based on the testing results on the fraction of desired advertising. The ad buy is submitted for subsequent approval by the advertiser, if pre approval of system determination(s) has not already occurred.

In this example, had the approval not been given, the $10,000 test buy may have been paid for with the equivalent in retail goods entirely, namely the “A” and/or “C” goods, based on system and advertiser approval and/or agreement. With advertiser acceptance of the ratio determined by the test, the test period can be incorporated selectively into the overall ad buy, or not, selectively. In this way, a glut of advertisers owning the system goods for advertising that has been procured, can be eliminated or minimized to allow user interactivity to drive and “release” additional thresholds and modified goods/cash ratios, and ratios pertaining to types of goods offered as redeemable items by the advertiser, relative to advertising or other interactive services acquired benefitting the advertiser.

In accordance with one or more embodiments of the present application, this organic, computer driven bartering system can be created with (but is not limited to) the following elements:

Users providing permissions and/or access to themselves for advertising, sampling, or other valued actions including responding to questions, other users, or exchanging media with the system and/or other users, among other options;

Advertisers provide, or offer to provide, branded goods and/or services, as an aspect of their ad buy, which can be categorized based on value aspect(s) by the system, based on advertiser and/or user provided information about the items including user interest demonstrated in items as variable option;

System computing determines and provides, and/or offers for advertiser approval, an advertisement fulfillment scenario(s) to advertisers; and

System computing may revise the scenario(s) for existing advertising buy(s) and/or future advertising, based on user interest or other data managed by the system providing an interface between users and brands and their respective interests.

In at least one embodiment, an advertiser can be limited in the media that may be purchased, based on interest and/or determined potential of the goods/services offered for payment. In such a limiting scenario, additional advertising can be secured by increasing the amount of cash and/or higher graded goods base on thresholds known to the system.

User redemptions of goods of an advertiser can trigger, optionally, optimal ad targeting of such users by such advertisers, as the very redemption of offered goods used to pay for advertising reveals premium group(s) of users interested in their goods. For example, redemption of an item(s) from last year, using 100 points for an originally listed $100 retail item, informs the system and interested advertiser of the user who may inform aspects of new product development and/or be likely to buy this year's new goods based on demonstrated interest in the brand.

Thus, a redeemer of sunglasses from last year, for example, may be organically revealed as a novel function of one or more embodiments of the present application, to inform the color, style or sales potential of a new good. This redeemer may also be a good ad target to lure toward the new styles for purchase directly or by way of advantage system managed option(s).

In at least one embodiment, advertisers preferably receive electronic “catalog redemption” orders from the system, related to fulfilling their ad buy commitment. Thus, preferably the system does not fulfill orders or manage goods literally, but simply relays information for the participating brands/advertisers to fulfill such orders. Additionally, user ratings of the fulfilled orders, both with regards to speed and/or customer service and/or other aspects, can represent a further example of user feedback that system computing can employ in making determinations of the ratio, or “blend” of goods and/or cash that an advertiser may be offered electronically.

Thus, one or more embodiments of the present application allow for plurality of tandem user and advertiser desires to be satisfied with a single ad buy involving goods all or in part for bartered acquisition of the paid media. In at least one embodiment:

Users set a variable control(s) affecting what and/or how much paid information they receive (and/or allow their information and/or media to be used in) which in turn allows users to accrue points redeemable for goods by simply providing this interactive access to them and/or their information;

Advertisers (via a computing device) make targeted advertising placement requests that can include criteria for targeting one or more users. The advertising placement requests can also include a request to barter (e.g., pay) for all or part of the advertisement with at least one product, good, and/or service from the advertiser. The request to barter can be subject to a computer-managed determination of one or more users' demonstrated interest in the advertiser's product(s), good(s), and/or service(s). This computer-managed determination can affect the amount of advertising that may be paid with by the product(s), good(s), and/or service(s);

Advertisers (via at least one processor configured with a programming code), using criteria received from one or more users and their own targeting criteria for users to determine at least one context element to be incorporated within one or more advertisements. The advertisement(s) can include at least some personal information and/or media generated by one or more users, who have been determined to be relevant to the advertiser. Relevance to the advertiser can be determined by, for example, having a personal interest or preference towards the products, goods, and/or services of the advertiser.

Brands set variable control(s) to place a media ordering, including at least one designation that may be of one or more aspect, including volume of media, user targeting criteria, number of venue(s) featuring the advertising, how much of the ad buy is in goods/services, and what goods/services are offered, among other discreet options;

Users interact, accrue rewards/incentive points (preferably of the same numeric value of the actual retail price of goods to maintain brand value and integrity as even old goods as “moved” through redemptions) and users literally receive items at their doorstep in all or at least some cases without any use of cash to acquire them; and

Merchants (also referred to here as “brands” and “advertisers”) find a powerful new conduit to use merchandise, not cash, to drive new interest and information in their brand and their new goods, while using the acquisition of valued, uniquely targeted and permission empowered advertising as a tool to also move even unsold (close out) goods as a means of paying for same.

Thus, extreme permissions by powerfully incentivized users gained to access social and/or other information and/or media to generate ads of customized relevance. Additionally, the very goods that can be redeemed provide a unique layer of user demographic targeting information, distinguishing once invisible users interest in a brand by way of redemptions, making them ideal advertising, sampling or special deal targets.

This is unique, as purchases on e-commerce sites, or even clicks/interest, is not a redemption using this value to the users that creates a separate targeting distinction from users purchasing items with cash or showing interest that falls short of “spending” credits that were earned and valued more than just their time spent reviewing paid information.

The present application is further described with additional implementations.

A computer operable system can be provided for driving the pace and/or quality of response data extraction and eliciting is provided. Social networks and other interactive venues, including wireless member based networks, often generate revenue in relation to the eliciting and selling (or remarketing) of information gleaned about their members or users. Such information includes, location, preference, trait, behavior, opinion, messaging, brand feedback, among other types of subjective and objective information specific to an individual(s). This information is used to “group” people and/or distinguish them, for sponsored information including advertising, sampling questions and solicitations for commercial opportunities among other options.

Herein, several distinctly weighed variables create value in relation to at least 4 variables, in one configuration. In other configurations, a combination of two or more of these variables represents a useful iteration of the computer implemented solicitation generating and rewarding system and method herein:

A time factor;

An advertising targeting factor related to the value of a user who is being solicited for specific information;

An incentive factor, related to points or other value earned by the user responding to the solicitation;

An incentive factor, related to merchandise and or other value provided by the brand/advertiser posing the question to the user.

A sequence of events managed by a computer operable system and linked venue(s) provides the following configuration:

An interactive network user has provided a permission to receive a sponsored solicitation in exchange for a reward, such as a point value that may be accrued;

A sponsor has provided, via a sponsor interface or similar access method for providing a commercial order for information and/or user(s) access, at least a preference related question in relation to a targeting criteria that narrows the user(s) solicited for information to a specific subset(s) of the overall membership or user-ship of the network;

A user is and/or has been informed that the time frame in which he responds to the solicitation/question impacts the potential incentive value he may earn by answering and in one configuration, the user has allowed “alert access” to him for such time sensitive reward driven opportunities to provide opinions and/or valued interactions from via his computing device (such as laptop, wireless device or other);

The sponsor (and question provider) has agreeably provided, via their associated computing device(s) in relation to their account with the system, an acknowledgement that certain respondents that are solicited will affect the overall compensation required, based on their “value” to the solicitation, based on factors including at least their value as a target, (such as an expert in the field of a data soliciting brand,) and/or their speed in providing a useful opinion, preference or other valued interaction or response, (among other possible factors of value agreeably affecting the “cost” of the solicitation).

In a preferred configuration, a time frame is set as a preferred or imperative response time, for the solicitor, in this case an advertising brand seeking preference information. As an example, Ray Ban brand sunglasses seeking information about what type of frame to finalize as their flagship style for the next year's product line.

Ray ban provides, in an important configuration, an amount of product and/or cash as a commitment to supporting, (paying for,) the solicitation process and information gleaned. They set a one-hour time frame for the solicitation. A “clock” or similar device, in one version, displays the “count down”. The respondents in the first 10 minutes, who have agreed to receive “alerts” of such data soliciting opportunities, receive enhanced rewards earning potential by providing their reaction(s) to the solicitations or opportunities (including purchasing opportunities) faster.

Thus, users as well, in on configuration, see a clock or other time related data point(s) that are visibly and/or systemically linked to the magnitude of rewards that that user's response may accrue.

The present application provides a powerful system for driving user willingness to provide valued, fast responses to consumer data and preference sampling is created. Extremely discreet demographic targeting of relevant members agreeing to be rewarded for participating, may include now a temporal reward variable that is known to both solicitor and recipient. Further, the solicitor being able to use the interface to “amp up” or enhance the incentive opportunity, may be like an auction scenario, entirely variable and potentially open-ended. Thus, extremely valued “focus groups” may be solicited and may earn unusually high rewards, for being available and available fast, to relevant solicitations.

For example, Ray Ban's new ski goggle options, might require a very fast response from expert skiers, for their product development team. Thus, an exponential enhancement, such as “10 times” normal rewards, might be offered to male expert skier members who respond within 30 minutes to the solicitation. Indeed, this scenario might result in a good bit of product and/or cash being allocated to the reward system at least, relative to each respondent, but the quality and pace of information extraction cannot be easily overstated as a value point, when a product or service can benefit from fast, high quality consumer feedback.

Thus, the present system creates an user and brand agreed basis, platform and transactional system for using (preferably) goods in part, to be provided to an incentive catalog, to compensate the active time-based solicitation of targeted members, leading to expeditious and useful consumer feedback from engaged and relevant members.

Further, in driving such interest to these high value questions, these users may become privy to new product options and brands that allow for subsequent targeting by the same brand or from others, who now may distinguish these users further as high value potential respondents. For example, the feedback from a user in relation to Ray Ban ski goggles, may demonstrate a higher value Expert Ski respondent, leading to Rossignol later using that gleaned status to solicit the same user for the new line of Ski's in development, in relation to color, size, and shape, etc.

The system generates potential margins of revenue, driven by the urgency of the data solicitations, allowing for (for example) 80% of the extra (“amped up”) incentive from the data solicitor to be passed on to the consumer respondent(s), keeping a margin for system revenue, be it cash and/or goods from the advertiser. Indeed this system may service both brands and consumers, as the data solicitors, for example. Users themselves, potentially providing items, such as auction users providing merchandise (or user simply “buying” access) to gain valued insights.

For example, soliciting a demographic of females to give feedback about the “look” a male might use for his prom, might involve a user of points to gain immediate and truthful feedback from relevant females who have no agenda but to respond truthfully in relation to earning an incentive for doing so.

Further, truth filters and other value filters, beyond timeframe may be imposed. For example, long form feedback involving verbal (typed, voice or other,) provided information, may be weighed for value according to discreet system priorities. A response of gibberish would indicate, in such as case, “little or not incentive traction” as little or not useful information correlation relative to the solicitation might be discernable by system algorithmic programming (for example).

Whereas, a substantive and useful respondent might earn a great many points, for example, by responding in ways valued by system programming. This, distinguishing that respondent further, as a “useful and timely respondent” overall leading to more frequent alerts and/or moving that user to a higher value category of data respondent overall. This may be a valued status, leading to extremely high incentive earning potential, for example. The opportunity for filtering those “gaming” the system, might lead to ceilings being imposed on their earning potential, even if for “probationary” periods, and/or their being removed from valued solicitation opportunities based on system determination that their data is of lesser value, truth or relevance overall.

In combination, a system that determines and drives valued data providers, linked with the solicitors into a merchandise driven incentive system is provided. The weighing of time and quality of response, is further driven by this computer implemented priority matrix, which leads to a new type and value of advertisement and opportunity for both network members and consumer (or user) data/info solicitors.

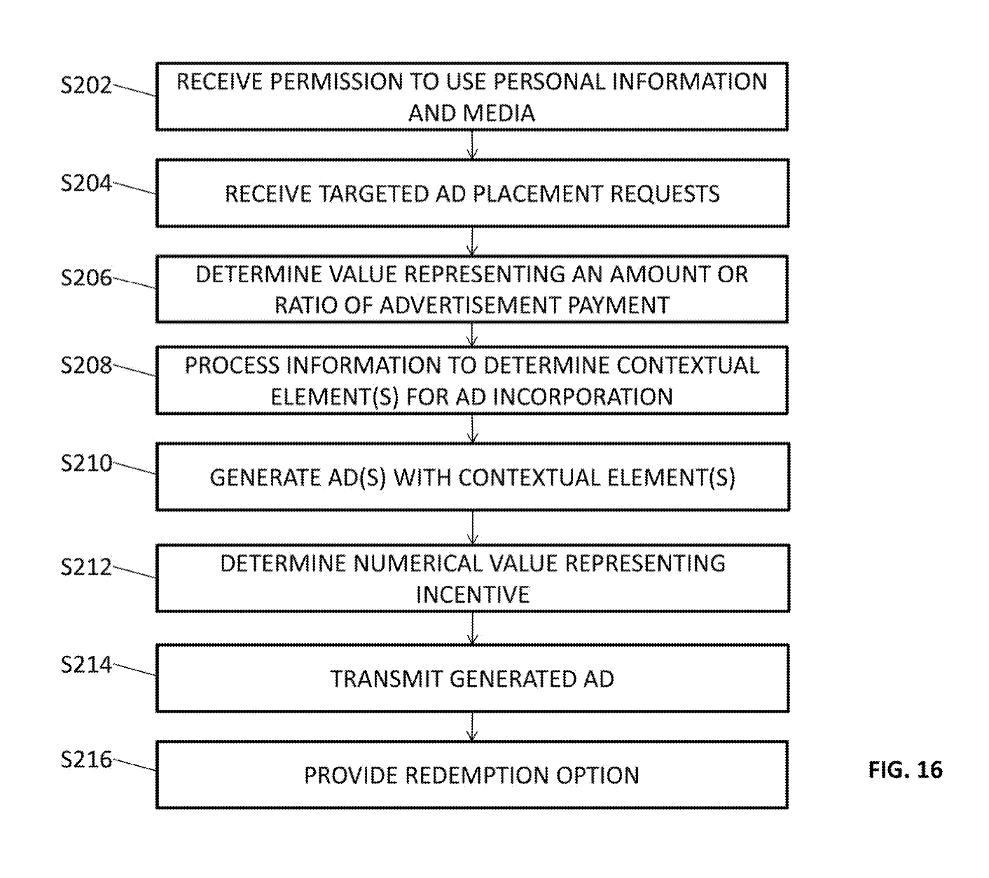

As one skilled in the art will appreciate, the present application provides for interactive computer managed media bartering. FIG. 16 is a flowchart illustrating example steps associated with an implementation. It should be appreciated that several of the logical operations described herein can be implemented (1) as a sequence of computer implemented acts or program modules running on a communication device and/or (2) as interconnected machine logic circuits or circuit modules within a communication device. The implementation is a matter of choice dependent on the requirements of the device (e.g., size, energy, consumption, performance, etc.). Accordingly, the operations described herein are referred to variously as operations, structural devices, acts, and/or modules. Various of these operations, structural devices, acts and modules can be implemented in software, firmware, special-purpose digital logic, and any combination thereof. It should also be appreciated that more or fewer operations can be performed than those in the figures described herein. These operations can also be performed in a different order than as described herein.

In the example steps shown in FIG. 16, the process starts at step S202, and information representing at least criteria that allows the use of a first user's personal information and/or personally generated media within advertising, is received using a processor executing instructions stored on non-transitory processor media. The information is received by the processor from the first user via a user computing device. Further, the information can represent variable permission for using the user's personal information and/or personally generated media within advertising. At step S204 targeted advertising placement requests are then received. In one or more implementations, the targeted advertising placement requests can include at least 1) criteria for targeting one or more users, and/or 2) criteria related to a request to barter for all or part of advertising using at least one product, good, and/or service.

Continuing with reference to the example flowchart in FIG. 16, at step S206 a value representing an amount and/or ratio of respective advertising that can be paid with the at least one product, good, and/or service is determined. This determination can be done in accordance with a demonstrated interest of plurality of users in at least one advertising product. At step S208, at least the information received from the first user and at least some of the criteria received from the one or more advertisers is processed to determine at least one contextual element to incorporate within an advertisement. The contextual element can include at least some of the personal information and/or personally generated media specific to at least one user. Thereafter at step S210, at least one advertisement with the at least one contextual element is generated.

With further reference to the flowchart shown in FIG. 16, at step S212 a numerical value representing at least an incentive for a targeted user to receive and/or be included within the contextual element in the advertisement is determined. The numerical value can be applicable towards a redemption option associated with the at least one advertiser product, good, and/or service. The targeted user is determined to be relevant by a personal interest in connection with the first user and/or at least one preference that is relevant to a respective advertiser. Further, the redemption option can be provided to at least one computing device associated with a user receiving the advertisement, in relation to the generated advertisement. Next, at step S214 the generated advertisement is transmitted to at least one computing device that is associated with a user receiving the advertisement. Finally, at step S216 the redemption option is provided to the targeted user.

Thus, as shown and described herein, an interactive computer managed method and system are provided for receiving personal information that includes criteria for using the personal information within advertising generated for users. Further, targeted advertising placement requests that include at least criteria for targeting user(s) and criteria related to a request to pay for all or part of advertising orders with at least one good and/or service can be received. The criteria received from the first user and the criteria received from at least one of the advertisers can be processed to determine at least one contextual element to be incorporated within an advertisement. Moreover, a numerical incentive value is determined that is at least associated with the advertisement in relation to a user targeted to receive the advertisement.

Although the present invention has been described in relation to particular embodiments thereof, many other variations and modifications and other uses will become apparent to those skilled in the art. It is preferred, therefore, that the present invention not be limited by the specific disclosure herein.

What is claimed:

1. An interactive computer managed media bartering system, comprising:
a processor and non-transitory processor readable media and instructions stored on the media wherein the processor, when executing the instructions, is configured to perform the steps of:
receive, from a first user via user computing device, information representing at least criteria that permits using the first user's personal information and/or personally generated media within advertising;
receive, from advertisers via at least one advertiser computing device, targeted advertising placement requests that include at least:
criteria for targeting user(s); and
criteria related to a request to barter for all or part of advertising with at least one product, good and/or service;
determine, in accordance with a demonstrated interest of a plurality of users in at least one advertiser product, good and/or service a value representing an amount and/or ratio of respective advertising that may be paid with the at least one product, good and/or service;
process at least the information received from the first user and at least some of the criteria received from at least one of the advertisers to determine at least one contextual element to incorporate within an advertisement, wherein the contextual element includes at least some of the personal information and/or personally generated media specific to at least one user;
generate at least one advertisement with the determined at least one contextual element;
determine, using the processor, a numerical value that represents at least an incentive for a targeted user to receive and/or be included within the contextual information within the advertisement that is applicable toward a redemption option associated with the at least one advertiser product, good and/or service;
transmitting, using the processor, to at least one computing device associated with an advertisement receiving user, the generated advertisement; and
providing the redemption option to the targeted user.

2. The system of claim 1, wherein the information received from the first user further represents variable permission for using the user's personal information and/or personally generated media within advertising.

3. The system of claim 1, wherein the generated advertisement is transmitted to the first user and/or a different user.

4. The system of claim 1, wherein the targeted user is determined to be relevant for having a personal interest in connection with the first user and a preference that is relevant to a respective advertiser.

5. The system of claim 1, wherein the redemption option is provided to at least one computing device associated with the advertisement receiving user in relation to the generated advertisement.

6. An interactive computer managed media bartering method, comprising the steps of:
receiving, using a processor executing instructions stored on non-transitory processor readable media, from a first user via a user computing device, information representing at least criteria that permits using the first user's personal information and/or personally generated media within advertising;
receiving, using the processor and from advertisers via at least one advertiser computing device, targeted advertising placement requests that include at least:
criteria for targeting user(s); and
criteria related to a request to barter for all or part of advertising with at least one product, good and/or service;
determining, using the processor and in accordance with a demonstrated interest of a plurality of users in at least one advertiser product, good and/or service, a value representing an amount and/or ratio of respective advertising that may be paid with the at least one product, good and/or service;
processing, using the processor, at least the information received from the first user and at least some of the criteria received from at least one of the advertisers to determine at least one contextual element to incorporate within an advertisement, wherein the contextual element includes at least some of the personal information and/or personally generated media specific to at least one user;
generating, using the processor, at least one advertisement with the determined at least one contextual element;
determining, using the processor, a numerical value that represents at least an incentive for a targeted user to receive and/or be included within the contextual information within the advertisement that is applicable toward a redemption option associated with the at least one advertiser product, good and/or service;
transmitting, using the processor, to at least one computing device associated with an advertisement receiving user, the generated advertisement; and
providing, using the processor, the redemption option to the targeted user.

7. The method of claim 6, wherein the information received from the first user further represents variable permission for using the user's personal information and/or personally generated media within advertising.

8. The method of claim 6, wherein the generated advertisement is transmitted to the first user and/or a different user.

9. The method of claim 6, wherein the targeted user is determined to be relevant for having a personal interest in connection with the first user and a preference that is relevant to a respective advertiser.

10. The method of claim 6, wherein the redemption option is provided to at least one computing device associated with the advertisement receiving user in relation to the generated advertisement.
